(19) United States
(12) Patent Application Publication
(10) Pub. No.: US 2004/0073507 A1
(43) Pub. Date: Apr. 15, 2004

(54) Method and system for providing international procurement, such as via an electronic reverse auction

(76) Inventors: William A. Scott, Roswell, GA (US); Kathryn D. Coffman, Greer, SC (US); Paula J. Duell, Austell, GA (US)

Correspondence Address: PERKINS COIE LLP, PATENT-SEA, P.O. BOX 1247, SEATTLE, WA, 98111-1247, US

(21) Appl. No.: 09/754,024

(22) Filed: Jan. 3, 2001

(51) Int. Cl. G06F 17/60

(52) U.S. Cl. 705/37

(57) ABSTRACT

A system for providing procurement, such as international procurement via an electronic reverse auction system, provides several components. Once the need to procure a new item (or service) is identified, a global commodity leader is notified to help identify leveraging across a large business organization. Substantially in parallel, suppliers for participating in a reverse auction are identified, a qualification plan for qualifying suppliers and items to be procured is established, and an electronic request for quotations (“RFQ”) is generated. Following completion of these tasks, the electronic RFQ is provided to identified suppliers under an auction and results received within a time limit established for the auction. The winning supplier is identified and feedback is provided to the winning supplier, as well as to other suppliers, to provide, for example, a smooth, beneficial and amicable transition between an existing supplier and a new supplier, if necessary. Purchase orders are placed with a new supplier, if necessary, to procure one or more items for testing, and qualification testing begins. Once qualification testing ends, purchase orders are placed with the supplier to procure the desired items. Purchase orders may be generated before implementing the auction to facilitate the placement of a purchase order once a winning supplier is identified. Some or all steps in the process are performed electronically, or with electronic forms (e.g., Web-based forms), to eliminate bottlenecks and streamline the procurement process.

### TECHNICAL FIELD

The disclosure relates generally to conducting commercial transactions, and more particularly, to conducting auctions, such as reverse auctions. BACKGROUND AND SUMMARY

Many businesses, particularly those in the manufacturing industries, wish to obtain raw materials and parts at the lowest possible price while ensuring quality, timely delivery and other factors important to the business. The requisitioning process for procuring materials or goods has often been a labor-intensive, inefficient and non-standardized process. In general, a buyer must first decide what he or she will buy; second, identify sources for items to be purchased; and third, identify what must be performed to qualify a source or an item supplied by a source.

FIGS. 1A and 1B show an example of a typical requisitioning process 100. Beginning in block 102, a buyer identifies something that needs to be purchased and when it must be delivered. In block 104 the buyer determines whether a purchasing contract is in place for the item. If so, then in block 106 the existing purchasing contract is employed. If not, then in block 108 the buyer identifies one or more suppliers capable of supplying the item. If in block 110, the buyer is not approved, then in block 112, the buyer must be preapproved, such as by executing a secrecy agreement.

In addition to identifying suppliers, the buyer must prepare an REQ. An RFQ, or “Request For Quotations,” contains information suppliers need to prepare a bid or quotation. An RFQ will likely also include information or details regarding aspects of the item to be purchased that are important or critical to the buyer. Typically, an RFQ is not reviewed for completeness and is often used only for domestic suppliers. Thus, certain additional information is not required, such as export control licenses and the like. When the RFQ is completed, identified suppliers (previously approved, or approved under block 112) receive the RFQ, such as by mail or e-mail, under block 116. In block 118, the business receives technical proposals and proposed deviations or exceptions to the RFQ from one or more suppliers. The buyer or other evaluator can determine whether the product or item proposed by a supplier is acceptable for the buyer's intended application. If not, the supplier may not be permitted to participate.

In block 120, bids begin to trickle in from suppliers. Under block 122, all bids are considered received by some cutoff point. In block 124, the buyer negotiates with one or more suppliers based on the received bids, and in block 126 determines a supplier from whom to purchase the desired item. In block 128, the buyer provides oral or written feedback to the suppliers identifying, for example, the supplier selected and possible reasons for the selection.

Under block 130, if the item purchased requires qualification, then in block 132, a qualification plan is defined by either the buyer, a quality assurance individual, or some other person. In block 134, the buyer or other individual requests samples from the supplier in order to execute the qualification plan. In block 136, the qualification plan is executed and the purchased items are tested. If the items do not qualify wider block 138, then in block 140 it is determined whether time exists to retest the items. If so, the process loops back to block 136, and if not, the buyer may renegotiate with the supplier or one or more other qualified suppliers, under block 142. If the samples pass qualification testing and the vendor does not have a vendor number under block 144, the buyer or other individual obtains a supplier or vendor number in block 146. Following blocks 130, 142, 144 or 146, “Material Requisition Planning” or “Manufacturing Resource Planning” (“MRP”) or purchasing system data is updated to include, for instance, a vendor number under block 148. In block 150, the MRP system automatically generates one or more purchase orders to purchase the required items.

An MRP system is a system by which purchasing contracts are planned based on the need date of the purchased item. For “direct material” (i.e., purchased material that is incorporated directly into a product to be sold), the MRP system employs or calculates a quantity of an item required based on sales that incorporate that purchased item. For “indirect material” (i.e., purchased material that is consumed rather than converted into a sold product), the MRP system employs or calculates appropriate reorder time/amount based on stock on hand and consumption rate. The MRP system contains complete supplier and product information, such as the most recent quotes, preferred vendor identification and the like. MRP systems include a database and a transaction engine that plans and records all purchasing activity for an organization. The MRP system contains logic such that, when an order is placed upon the business by one of the business' customers, the system determines which items must be ordered from which suppliers and at what times (including delivery) so that the business organization can manufacture and deliver the customer's order on-time. The MRP system also contains reorder logic to ensure that an appropriate number of the items are kept on hand. MRP systems are well-known in the art of employing automated software tools to perform such processes. They automatically generate purchase orders, as required, to purchase items the system forecasts will be needed by the anticipated delivery date of such items.

There are many bottlenecks in the process described above. Examples of such bottlenecks are indicated by ovals within FIGS. 1A and 1B. For example, mailing or even e-mailing RFQs, particularly lengthy RFQs, leads to delays. Previous methods of identifying new suppliers not previously known to the buyer were haphazard, and approving such suppliers could he a lengthy process. Thus, buyers often failed to identify good alternative suppliers for a given item to be purchased. Preparing RFQs was a lengthy process, as each RFQ typically differed between buyers, and even between items purchased by a single buyer due, e.g., to differences between items and differing end uses. Many other problems resulted in bottlenecks in the requisitioning process.

Another method of requisitioning items involves “integrator buyers.” Some businesses have effectively outsourced or contracted out purchasing functions to integrator buyers. The integrator buyer manages inventory and reorders for the business; however, there exists a conflict of interest where competitors are approached for price negotiations and the like by the integrator. A less risky approach would be for the business to contract out the purchasing function to a firm that specializes in purchasing but supplies nothing to the business.

One previously used method of improving the product requisitioning process was to identify common items to be purchased across business groups or by various buyers within a large organization. For example, a “Global Commodity Leader” (“GCL”) would be employed who had the responsibility to be a single commodity expert across an entire business (across distinct profit and loss centers). The GCL strategized where and how to purchase, how to leverage volume, and how to split purchases to best utilize or manage an available supply base. The GCL worked for a sourcing functional manager rather than directly for production within the organization. As indicated by their title, GCLs were expected to be familiar with the entire world's supply capability and price structure for their particular commodities. GCLs relied upon buyers to actually purchase items and ensure delivery. Nevertheless, despite the use of GCLs, many problems existed. The above process can be made more efficient.

A problem with prior requisitioning systems was that they were typically inefficient at managing high-volume activities, incapable of handling high-speed negotiations, incapable of purchasing foreign-manufactured goods, unable to leverage across business units, ineffective with communications and transactions, and fraught with time-zone problems and/or other problems. For example, an RFQ may have been provided to suppliers without providing the suppliers with corresponding adequate preparation time. After a supplier was selected, problems arose when a purchase order could not be immediately provided for that supplier because they must first be approved, or because of qualification issues regarding items to be purchased. In general, bottlenecks occur in generating and distributing the RFQ (e.g., gathering and including drawing and pictures, identifying leveraging opportunities), obtaining vendor numbers, updating MRP or purchasing systems, preparing a qualification plan (e.g., identifying test quantity, test site and protocol, test support personnel, past/fail criteria), qualification testing (e.g., obtain delivery of sample orders, executing the qualification plan, obtaining supplier participation when necessary, generating International Standards Organization (“ISO”) change requests), and providing supplier feedback. These are only some of the problems encountered under prior systems.

Prior attempts to automate the requisitioning process included using e-mail. However, e-mail often has limitations in sending large electronic documents. Further, many steps in the process described above are manual. Inventors have found that a public computer network, such as the Internet, may be employed to provide efficiencies for purchasing.

The Internet is being used to increasingly conduct “electronic commerce.” The Internet comprises a vast number of computers and computer networks that are interconnected through communication channels. Electronic commerce generally refers to commercial transactions that are at least partially conducted by using the computer systems of parties to the transactions. For example, a purchaser can use a personal computer to connect to a vendor's computer via the Internet. The purchaser can then interact with the vendor's computer to conduct the transaction.

Although many of the commercial transactions performed today could be performed via electronic commerce, the acceptance and wide spread use of electronic commerce depends, in large part, upon the ease-of-use of conducting such electronic commerce. If electronic commerce can be easily conducted, then even the novice computer user will choose to engage in electronic commerce. Therefore, it is important that techniques be developed to facilitate conducting electronic commerce.

The World Wide Web portion of the Internet is especially conducive to conducting electronic commerce. Many Web servers have been developed through which vendors can advertise and sell products. These products can include items (e.g., music) that are delivered electronically to the purchaser over the Internet and items (e.g., books) that are delivered through conventional distribution channels (e.g., a common carrier). More generally, an item is any product, service, or exchangeable entity of any type. A server computer system may provide an electronic version of a catalog that lists items that are available. A user, who is a potential purchaser, may browse through the catalog using a browser and select various items to be purchased. When the user has completed selecting the items to be purchased, the server computer system prompts the user for information to complete the ordering of the items. This purchaser-specific order information may include the purchaser's name, the purchaser's credit card number and a shipping address for the order. The server computer system then typically confirms the order by sending a confirming Web page to the client computer system and schedules shipment of the items.

The World Wide Web is also being used to conduct other types of commercial transactions. For example, some server computer systems have been developed to support conducting auctions electronically. To conduct an auction electronically, the seller of an item provides a definition of the auction via Web pages to a server computer system. The definition includes a description of the item, an auction time period, and optionally a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

A reverse auction may be preferred for procurement. A “reverse auction” is one in which the purchaser states requirements; then, suppliers who can meet the stated requirements compete for the business by offering the lowest price, quickest delivery, or whatever other conditions are sought by the purchaser. It is “reverse” because the usual competitive factor is price, and unlike a typical auction (“forward auction”), price goes down as the auction progresses.

As described in detail below, a method to convert a manual purchasing process, including prerequisitioning functions, to an automated Web-based model employs new business units and Web forms to reduce or remove bottlenecks and improve overall product-purchasing efficiencies.

### BRIEF DESCRIPTION OF THE DRAWINGS

FIGS. 1A and 1B together form a flow diagram illustrating an example of a prior art procurement process.

FIGS. 2A and 2B together form a flow diagram that illustrates one embodiment of a procurement process under aspects of the invention.

FIGS. 3A and 3B together form a flow diagram that illustrates an alternative embodiment to a procurement process under aspects of the invention.

FIG. 4 is a flow diagram illustrating more detailed aspects of the processes of FIGS. 2A-3B.

FIG. 5 is a schematic diagram illustrating a suitable system for implementing aspects of the invention.

FIG. 6 is a block diagram illustrating a suitable hardware environment for implementing aspects of the invention.

FIG. 7 is an organization diagram illustrating an example of an organizational grouping implementing electronic auction procurement under aspects of the invention.

FIG. 8 is a block diagram illustrating exchange of information between organizational units, including some of those depicted in FIG. 7.

FIGS. 9A through 9V are examples of Web pages for implementing an electronic auction under aspects of the invention.

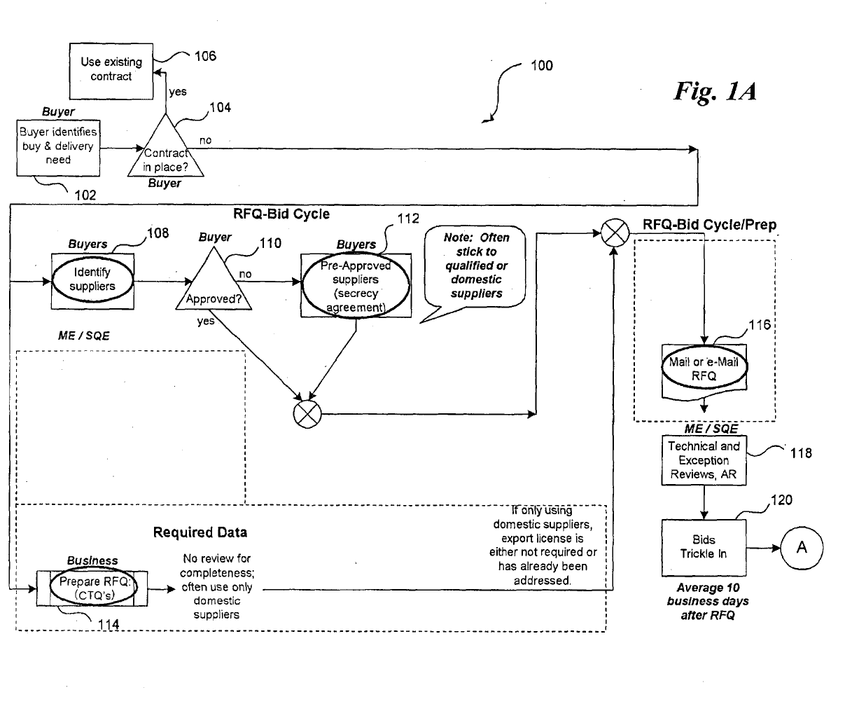

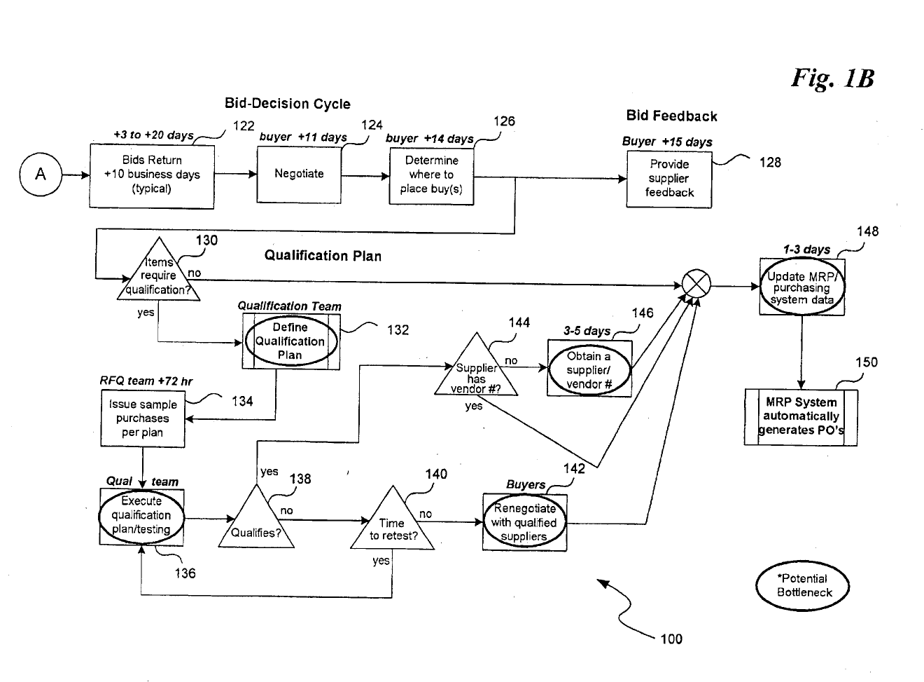

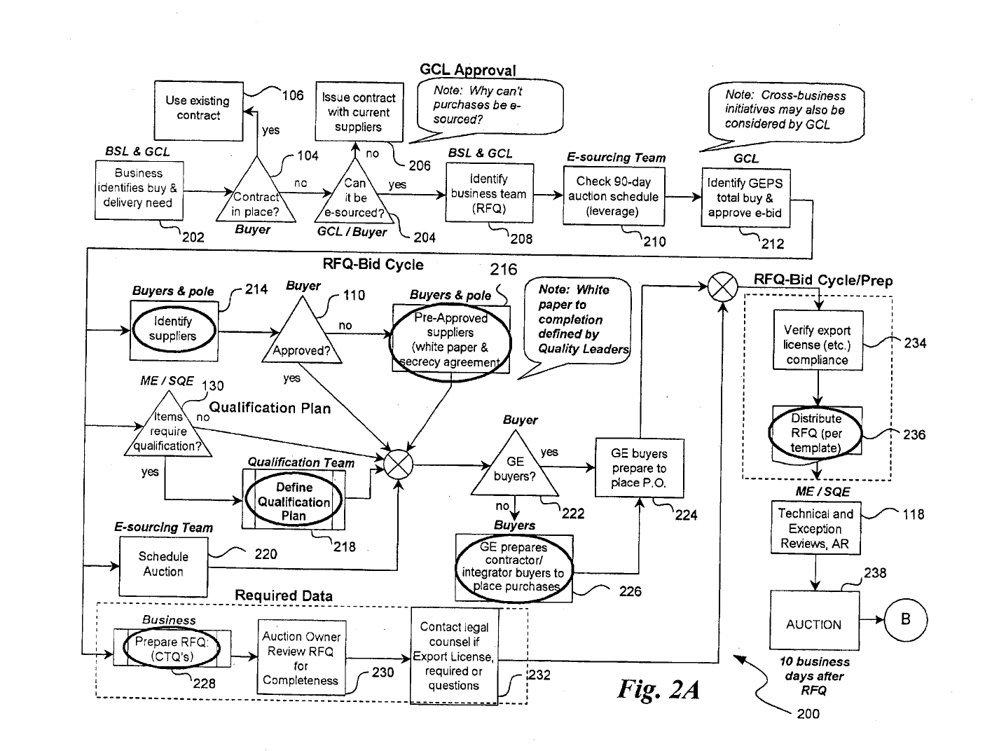

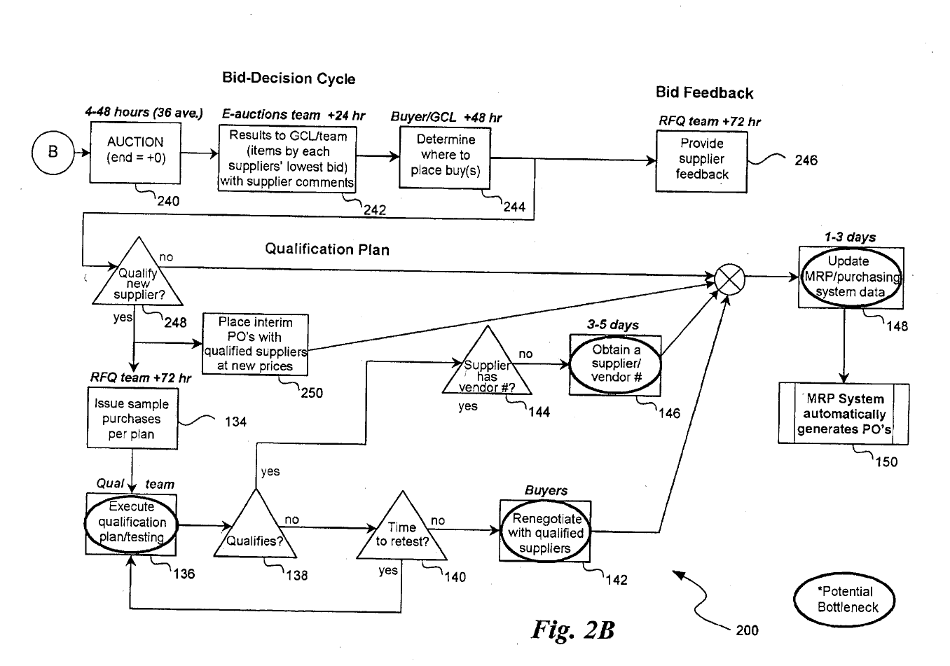

In the drawings, identical reference numbers identify identical or substantially similar elements or acts. To easily identify the discussion of any particular element or act, the most significant digit or digits in a reference number refer to the Figure number in which that element is first introduced (e.g., block 204 is first introduced and discussed with respect to FIG. 2).

The headings provided herein arc for convenience only and do not affect the scope or meaning of the claimed invention.

### DETAILED DESCRIPTION

A process for preparing, executing, and fulfilling procurement needs by using electronic auctions, primarily reverse auctions, is described in detail below. In the following description, numerous specific details are provided, such as specific organizational tasks, ordering of processes, necessary qualifications, and the like, to provide a thorough understanding of, and enabling description for, embodiments of the invention. One skilled in the relevant art, however, will recognize that the invention can be practiced without one or more of the specific details, or with other functions, tasks or processes, etc. In other instances, well-known structures or operations are not shown, or are not described in detail, to avoid obscuring aspects of the invention.

In general, a process, described in detail below, identifies organizational responsibility and relative timing necessary to procure many types of required items under a requisitioning process, all with the aid of an electronic auction tool. The process addresses International Standards Organization (“ISO”) procedures for obtaining quotes, approving purchases, approving new suppliers, and qualifying new products. Additionally, procedures are identified that carry out electronic requests for quotations (RFQs), reviews, negotiations, and internal measurements or testing. These procedures or processes work with the electronic tools (including electronic auctions) to facilitate provision of an effective model so that organizations can use electronic procurement as a purchasing tool.

As explained in detail herein, the disclosed process encompasses ISO procedures of each distinct business unit such that employing the process does not violate any existing ISO procedures. The disclosed process requires approval of a Global Commodity Leader (“GCL”) to ensure business-wide leveraging. The process identifies optimum sequencing of events to avoid process stalls and bottlenecks and resolves timing conflicts. The process identifies ownership of tasks consistent with an efficient emerging purchasing organization. The process is measurable for potential process improvements, such as improvements to reduce the cycle time and variation control. The process may be used with all existing computerized purchasing systems.

Referring to FIG. 2A, preauction processes performed under a method 200 are shown. Beginning in block 202, a business organization employing the method 200 identifies an item to purchase and when that item must be delivered. A buyer within a large business or organization having separate profit and loss centers identifies to a GCL that an item or group of items must be purchased. Alternatively, the separate profit and loss center or business unit may designate a Business Electronic Sourcing Leader. A “separate business unit” or “business unit,” as generally used herein, refers to a separate profit and loss center or group within a larger business organization. A Business Electronic Sourcing Leader (“BSL”) is delegated by each business unit to migrate sourcing or requisitioning activities into more efficient electronic methods. The BSL's role, with respect to electronic auctions, is to ensure that business goals, such as sufficient percentage of procurement performed through electronic auctions are met, savings targets are established and accomplished, and the like.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

Typically, a buyer under block 202 informs the BSL and/or GSL of the need to purchase the particular item. For example, the buyer may inform the BSL and/or GSL by email or by employing a Web page form completed by the buyer. This is routed to the appropriate individual by using known communication means such as a mail server. The BSL may be the buyer. A “buyer,” as generally used herein, refers to an individual or group that works for production and is chiefly responsible for maintaining work flow by contracting for and ensuring delivery of purchased items. Buyers are typically very familiar with a finite scope of purchased items, established suppliers of those items, and the logistics and timing issues involved with procuring those items. In practice, buyers have traditionally handled negotiations for purchases; under alternative embodiments, GCLs perform some negotiations to leverage volume, share best practices and use preferred suppliers.

After determining that a contract is not in place under block 104 (or after determining that it is desirable to discontinue an existing contract). In block 204 the GCL or buyer determines whether the item can be sourced or requisitioned electronically, such as under an electronic auction. If the item cannot be procured under an electronic auction, then a traditional request for proposals and negotiated process is employed under block 206, terminating in a contract with qualified suppliers under the process 100 described above. In general, an electronic auction is not appropriate with sole-source or single-source contracting. Sole-source contracting typically refers to the existence of a contract requiring the business to buy items from only one source; single-source contracting typically refers to where only one supplier has been identified and is being used for procurement (although others may likely exist). Apart from sole- and single-source contracting, most items can be electronically sourced, given appropriate preparation. Hurdles to electronic contracting that may be identified under block 204 include that the supplier is unqualified and new, that there are technical logistics to sharing drawings, that customs clearance must be performed and the like. However, these hurdles typically may be overcome to support an electronic auction. Thus, the GCL, buyer or other individual may attempt to clear such hurdles to permit an electronic auction for purchasing the item.

In block 208, the BSL and GCL identify a necessary business team to assist in preparing the RFQ. Such a business team is generally a person or group of individuals who know of the auction activity. Depending upon the organizational structure and the item to be requisitioned, the composition of the person or group may vary. Generally, at a minimum, a buyer and/or GCL should prepare, or assist in preparing, the RFQ. Also, a BSL should be aware of the auction activity, even if the BSL is not actually managing the auction, to ensure proper prioritization to meet business objectives and the like. Other personnel may be called upon to review the RFQ for clarity and completeness. Such additional personnel may include pole personnel (e.g., to ensure that “national standards” do not impede the use of global suppliers, that local customs are observed, etc.), manufacturing engineers (e.g., to ensure that drawings and specifications are accurate, to identify any additional information that must be included in the RFQ, etc.), environmental health and safety individuals, legal staff and the like.

A “pole,” as generally used herein, refers to a specific region of the world that has been targeted as having a low-cost, high quality or other required supply base for items consumed by a purchasing organization. Examples of such poles include an Asian pole (includes Singapore, China, India, Japan, etc.), a European pole (includes the European countries), an Americas pole (includes Central and South American countries) and the like. Poles may be also be defined based on smaller geographic regions, such as separate eastern and western European poles (rather than a single European pole). A pole may be a preferred source for particular items, such as the Asian pole for textiles and hand tools, due to labor costs within such regions. Within each identified pole, sourcing engineers are located. “Sourcing engineers” are personnel who identify and develop good suppliers within that region and may be the pole personnel themselves. Pole personnel are generally local nationals working directly with suppliers and national commerce organizations to attract business into the geographic region. Thus, they work with the GCL, for example, to encourage bids under an electronic auction to suppliers within that pole.

In block 210, an e-sourcing team checks to determine whether an auction may be held at some future time, and reserves or schedules an auction for that time. For example, the auction may be scheduled 90 days into the future, which permits the GCL to augment the auction, if possible. An “e-sourcing team,” as generally used herein, refers to a central functional group whose purpose is to schedule and facilitate electronic commerce for all business units. The group ensures that both buyers and suppliers have appropriate protected access to business tools which are used to prepare for and conduct electronic auctions. This group maintains a help desk during auction events to assist with any technical problems or other questions that may arise, and thereby facilitate the auction. The group ensures training of all users, both buyers and suppliers, in using the process. Furthermore, the group reports overall business metrics with respect to electronic procurement, business objectives or a “business road map,” as discussed below. Under block 210, the e-sourcing team ensures that the Web-tools and help desk are available to support the auction at the scheduled time, and also notifies the GCL of such auction. The GCL may in turn identify near-term auctions that could potentially be combined to provide a more attractive opportunity for potential suppliers. For example, if one business unit wishes to purchase one type of tool, while another business unit wishes to purchase a similar tool, then combining such requisitions together to increase volume may lead to better bids under the auction.

In general, the GCL may consider cross-business initiatives. “Cross-business,” as generally used herein, refers to sharing information for grouping purchased volumes of items for the sake of better negotiation with suppliers. Cross-business refers to collaboration between businesses with different organizational structures and distinct operational objectives. For example, a large organization having both an aircraft engine business and an industrial systems business may have two totally different operations, but the businesses may be able to collaboratively buy common items, such as hand tools or small batteries, under the leadership of the GCL. Thus, under block 212, the GCL helps drive separate business units with similar product demands together to thereby add their needs to the proposed auction event. For example, one business unit that uses 20 to 30 D-sized batteries per year can reap the benefits from an auction conducted by a second business unit that uses 2,500 D-sized batteries per year by participating in the same battery auction. In general, while the processes are described herein for procuring items, the process may also be performed for procuring services to be performed.

In block 214, the buyers and one or more pole personnel identify suppliers for participating in the auction. The most obvious suppliers are those that have already been “qualified” to supply the items being auctioned. Many new suppliers, however, may be qualified with reasonable effort. Thus, permitting new suppliers to bid inspires qualified suppliers to be more competitive. New suppliers also help to manage risk, particularly where delivery or capacity issues exist. New suppliers are typically identified by either the buyer or by pole personnel such as pole sourcing engineers. Identifying a new supplier requires knowing at least the following information: type of products or services provided by the supplier; the name and address of the supplier; the name and phone, fax, or e-mail of a representative (such as a sales or account management representative) for the supplier, and the like.

If a supplier is not approved under block 110, then in block 216, suppliers are preapproved by the buyer or pole personnel. Preapproval of a supplier may involve completing a white paper. A “white paper,” as generally used herein, refers to a business-standard questionnaire that queries the supplier through a self-survey for types of issues that require investigation during a supplier approval audit. Such issues include financial practices, quality systems, ethics, labor standards and the like. For example, the white paper may be a computerized spreadsheet containing separate questionnaires for obtaining the following information about a potential supplier: initial preparatory information, prescreening information, supplier evaluation information, determination of a supplier's quality control systems, determination of delivery methods for the supplier, determination of regulatory compliance (e.g., labor, environmental health and quality, safety and the like), manufacturing and engineering capabilities, financial position, general business considerations (e.g., whether they have a Website, email, understand English, have labor dispute history, and the like), etc. The initial preparatory information may include the company's address, contacts, business structure, major facilities, information regarding its manufacturing and engineering capabilities, its top customers, its quality assurance capabilities, etc. The prescreening information may include more detailed information regarding the company's location, employment breakdown regarding number of employees per manufacturing/design group, financial information, more detailed manufacturing and engineering information, more detailed information regarding its quality systems, information regarding its transportation and delivery capabilities, information regarding its compliance with respect to relevant regulatory matters (including health and safety), information regarding visual inspection of its facilities and intellectual property information. The supplier evaluation information or form may include further commercial and financial information regarding the supplier, further detailed information regarding the manufacturing, engineering and quality assurance capabilities of the supplier, further information regarding regulatory compliance, etc. Each of these documents, in turn, may be individually considered the “white paper.”

In general, approving a supplier is a process of audits (financial, legal, ethical, etc.) conducted to determine whether the supplier is an entity capable of supplying items for the organization, and whether it conforms to all relevant laws, ethics and financial practices required by the organization conducting the auction.

The white paper may be completed by quality leaders. A “quality leader,” as generally used herein, refers to a business-specific leader of a quality assurance program performed within the organization. The quality assurance program may be any generic quality program, and quality leaders involved in any process that requires changes to supplier audits, or other procedures such as ISO procedures.

If the items to be purchased require qualification, then a qualification team defines a qualification plan under block 218. “Qualification,” as generally used herein, refers to qualification procedures that must be performed for both direct and indirect materials. Qualification is a process of validating that a specific item or material a supplier proposes to provide under a bid is acceptable for the specific application for which it is being purchased. Unlike supplier approval, qualification requires that the exact item be verified as acceptable for its intended use. Qualification procedures may vary significantly from common items (e.g., a buyer may change suppliers of flashlight batteries with a small change to paper or electronic records) to very high-tech items (e.g., a manufacturing engineer can change only such items after extensive destructive testing witnessed and recorded by a group of individuals, such as a Qualification Team).

A qualification procedure may vary significantly based on the items to be purchased. Some items to be purchased may have certain Critical To Quality characteristics (“CTQs”) which, as generally used herein, refer to criteria by which purchased items are evaluated. For example, tool durability, tolerance and cost might be three CTQs for cutting tools. CTQs may also be applied to processes and not simply items to be purchased.

A “Qualification Team,” as generally used herein, refers to a team comprised of individuals who work for production operations. Depending upon the level of qualification required, the following types of personnel may be involved: manufacturing engineers, buyers, quality control engineers, environmental health and safety engineers, operations leaders and/or machinists/operators.

Thus, under block 218, the Qualification Team defines a qualification plan that establishes a measurable set of criteria for determining whether a new item may be qualified for its intended use. Qualification applies to both new suppliers, as well as old suppliers offering a substitute product that has never before been used in its intended application. Some commodities, for example, shop rags, need no qualification. Others (e.g., electrostatic discharge machine wire) may require extensive destructive and non-destructive testing to be qualified. ISO or other procedures established by the Qualification Team become a major part of a post-auction action plan (described below).

The qualification plan is defined before the auction begins. As a result, once a winning supplier is identified, the business may immediately begin ordering one or more items from the winning supplier and testing such items. Thus, this system provides a concrete, tangible improvement over prior systems by expediting the procurement process. This leads to improved production and quicker savings to the organization, as well as to other benefits.

In block 220, the e-sourcing team schedules the auction in a manner similar to that described above with respect to block 210. Block 220 is the final planning step to ensure that the Web or Internet tools and help desk resources are available and adequate during the planned auction time. In other words, this is a double-check procedure. Time zone considerations should determine how long an auction will last, and thus will affect scheduling.

Often, the buyer or business unit must know in advance what purchases should be made immediately after the auction. For example, if qualification is potentially required (such as for a new supplier or new item), then there should be a plan to purchase enough of the requested item to complete qualification. Alternatively, the organization may request free samples of the item on which to perform qualification testing. In block 222, the buyer determines whether the purchase is to be made by the organization conducting the auction or by some third party. For example, three types of buyers may exist: a buyer employed by the business, a buyer who is a contractor or contract employee of the business, or third party supply buyers who perform purchasing functions for the organization. If the buyer for the auctioned item is a distributor, integrator buyer or integrator supplier, some additional time may be required to establish distributorships or other relationships with bidders with whom the integrator/distributor has never worked.

Under block 224, the buyer of the organization prepares and places a draft purchase order if the purchase is to be by the organization or, after receiving additional information (under block 226), if by a third party Thus, if the purchase is by the organization itself, then purchase order preparation need only include how much of and when to order the items. Thus, once the auction is complete and yields an identification of the winning supplier, the purchase order is essentially complete and can be placed immediately after inserting information regarding the winning bidder under the auction. Alternatively, some new suppliers may require that a third party buyer first become a distributor with them before supplying the requested item to the business. Thus, a reasonable amount of time must be reserved to permit such third party buyers to become distributors with one or more suppliers. Of course, other arrangements are possible that may delay the RFQ process. In a manner similar to that with respect to qualification planning, early preparation of purchase orders provides numerous benefits to the business organization.

In block 228, the RFQ is prepared by the relevant business that requires the items initially identified under block 202. The RFQ includes CTQs for the item to be procured. The RFQ must contain sufficient information to permit the least experienced supplier to adequately prepare a quote. Thus, items to be purchased must be described in as much detail as possible. Projected quantities to be purchased and anticipated delivery date requirements should also be stated in the RFQ. Shipping and currency preferences should be identified (e.g., all quotes in US dollars, pricing Free on Board (“FOB”) Charleston, S.C., etc.). The RFQ should also indicate whether bidder participation is required in preauction conferences, in technical reviews, or in other required procedures before, during or after the auction.

In block 230, a manager of the auction (the “auction owner,” such as the buyer or member of the business group requisitioning the item) reviews the RFQ for completeness. This final review ensures that all required data is provided in the RFQ.

In block 232, the auction owner contacts legal counsel if an export control license is required or further legal questions exist. If, for example, drawings or raw materials are to be exported to suppliers which might result in export control issues, legal counsel should be involved in assessing whether the item to be purchased can be sourced outside the U.S.

In the system 200, several processes are performed concurrently, such as identifying and approving suppliers under blocks 214, 210 and 216, defining a qualification plan under blocks 130 and 218, scheduling an auction under block 220, and creating and reviewing an RFQ under blocks 228, 230 and 323. Thus, the system again provides concrete, tangible results over prior systems by expediting the procurement process. Among other benefits, this leads to quicker realization of savings under an auction, more streamlined, coordinated processes within the organization, and the like.

In block 234, just before distributing the RFQ to suppliers, the RFQ is verified for any legal requirements, such as ensuring that all export license compliance issues have been resolved (for instance, confirming that an export control license has been received). In block 236, the RFQ is distributed to the list of suppliers identified previously under block 214.

Following the technical review under block 118, the auction is performed under block 238. Typically, under a reverse auction, the auction is held for a reasonable period of time, e.g. one to three hours, with extension logic. Extension logic effectively extends the time limit for the auction if significant activity occurs with respect to the items identified in the RFQ. Such short auctions permit pole participation despite distant time zones and thus, may require bidding at all different hours of the day depending upon the current time in a supplier's time zone. An example of an electronic auction system that may be employed is the LiveExchange System by Moai of San Francisco.

Referring to FIG. 2B, processes performed under the method 200 following the auction are shown. In block 240, the auction ends and under block 242, results of the auction are made available through the e-sourcing team or automated reporting tools. These results may be provided to the auction owner within a reasonable time after the auction, such as within 12 hours. In block 244, results of the auction are tabulated, and the GCL, buyer, or both determine from which supplier orders are to be filled. Qualified suppliers who have underbid their prior prices may get immediate purchase orders. The lowest bid does not necessarily equal the lowest cost. In some cases, a “comments” field (described below) associated with an auction may be as important as a supplier's bid (in a “bid” input field), since the comment may contain sufficient justification to procure from a supplier other than the lowest bidder. Such considerations may include services the supplier provides (e.g., warehousing, shipping, delivery, restocking, etc.) and quality (e.g., as it affects consumption rate, where half the price at three times the consumption rate would not correspond to a favorable bid).

In block 246, the RFQ team provides feedback to suppliers. Following an RFQ process, most suppliers wish to determine how they did relative to other suppliers. Under this step, all suppliers may be notified of the successful bidder. If the business organization is currently using one supplier, and a second supplier wins the auction, the business may wish to permit a tactful transition from the first, or existing, supplier to the second, or new, supplier. The business may wish to ensure that the first supplier does not go out of business, or otherwise seriously harm the first business (such as if it had previously ramped up production and had a great inventory of items that will now be purchased from the second supplier). The business may wish to have two or more viable suppliers who compete on future RFQ's, provide at least two sources for a required item or otherwise maintain the viability of two suppliers, so that if problems arise with one, the business may resort to procuring desired items from the other.

Under block 246, the method 200 permits beneficial conversion from one supplier or product to another. The business organization may create and implement a conversion plan such as the following. The business identifies all current suppliers of each item auctioned. The business also determines the logic associated with the MRP system (such as the amount of stock necessary to have on hand (“safety stock”), lead time for receiving items, usage rate of the items, etc.). The business may review supplier contracts to determine if and how to legally disengage an existing supplier if a new supplier is to be used. The business determines any warehousing services that are provided by the supplier, and determines if the supplier has any “unusable stock” that the business may wish to purchase from the supplier so as to not alienate it. The business then considers all this information and determines whether and how to best convert from one supplier or product to another while still maintaining good relationships with the previous supplier.

As explained herein, the transition plan for a new supplier may also include qualification plans for the new supplier when the supplier has not been qualified to provide the particular item for which that supplier had successfully bid. For example, the system or buyer may immediately accept the lowest bid from the current supplier as an interim purchase price, even though another, new supplier won the auction with a lowest bid. (The best price offered by the current supplier usually goes down during the auction and thus may be used immediately, regardless of whether the current supplier will remain the long-term supplier.) Following the auction, the current supplier is used until a new supplier can be qualified. If the new supplier fails to be qualified, a time limit is established after which qualification efforts will end for the new supplier, and qualification will begin for the supplier with the second to lowest bid. Until a qualified new supplier is transitioned in, the current (old) supplier continues to supply the item at the lowest bid they provided under the auction. Of course, the current supplier must know when they are no longer required to supply in order to manage their inventory/production.

Under one embodiment, suppliers know immediately whether their bid is the lowest bid. However, if a supplier has not submitted the lowest bid, they do not know the difference between their bid and the lowest bid. Under this embodiment, the buyer may provide feedback to the nonwinning suppliers by electronic mail or telephone call. The lowest bid does not necessarily equal the lowest cost or best purchasing arrangement (e.g., logistics, order-to-delivery cycle, or technical adequacy of an item may be important). Under another embodiment, the system may automatically generate electronic email messages to the nonwinning suppliers that include standard information to be sent to all suppliers, an automatically calculated amount between a supplier's final bid and the winning bid, and a portion in the email message for the buyer to fill in specific information for that particular nonwinning supplier to thereby quickly provide appropriate feedback.

Supplier transition planning helps ensure that the business organization maintains access to needed items while still attempting to achieve the lowest possible price for those items. Suppliers are not alienated, but encouraged to participate in one or more auctions for various items. Thus, the system provides beneficial results to the organization, including an ensured supply of needed items, low costs, etc.

In block 248, if the supplier is new and must be qualified, then under block 250, interim purchase orders are placed with prequalified suppliers to purchase samples for testing under the Qualification Plan. If previously qualified, then the purchase order may be placed directly. Thereafter, steps 134 through 150 are performed as explained above.

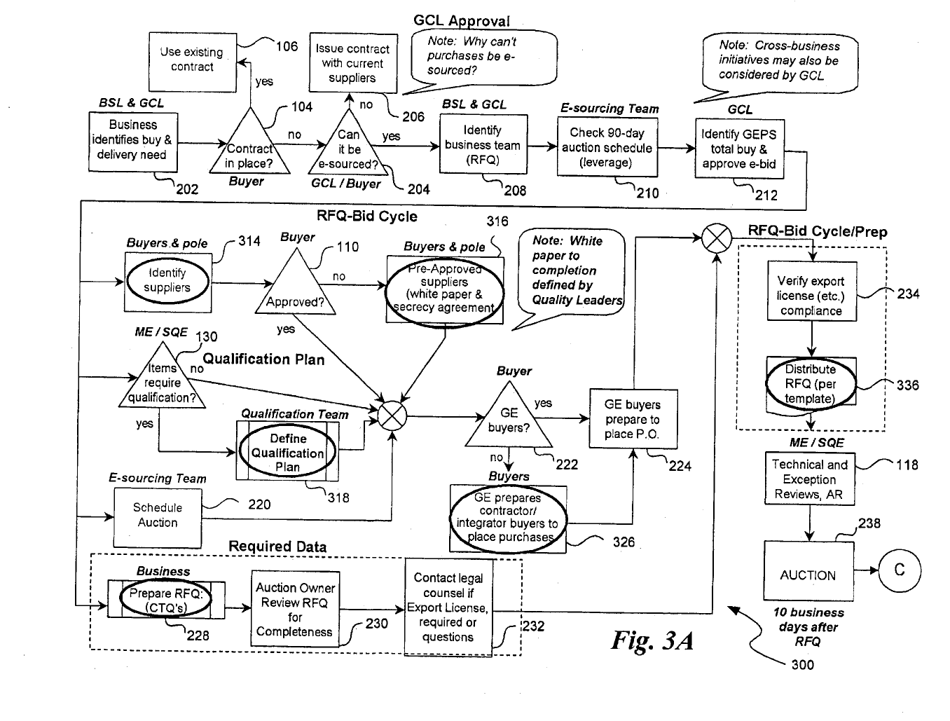

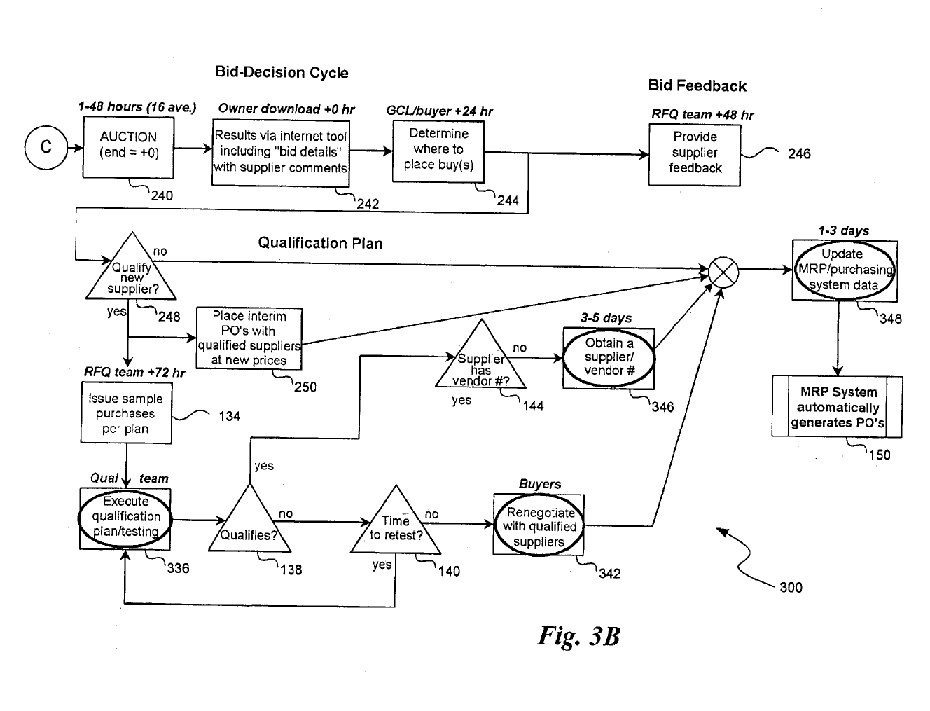

Referring to FIGS. 3A and 3B, an alternative embodiment to the method 200 is shown as a method 300. In general, alternatives and alternative embodiments described herein are substantially similar to previously described embodiments, and common elements and acts or steps are identified by the same reference numbers. Only significant differences in construction or operation are described in detail.

Various bottlenecks are possible under the method 200 of FIGS. 2A and 2B. Such bottlenecks typically occur because of processes performed manually or inefficient communication between individuals or groups. Under the method 300, such bottlenecks are replaced by automated tools. For example, when an auction is initially established, tasks are assigned to various individuals in the organization to perform various functions such as identifying suppliers, pre-approving suppliers, defining a qualification plan, generating and reviewing an RFQ, etc. Further details regarding assigning and managing tasks may be found in U.S. patent application Ser. No. ______, filed ______, entitled Method And System For Assigning And Tracking Tasks, Such As Under An Electronic Auction (Attorney Docket No. 24376-8039). Under block 314, suppliers are identified with an automated tool. Such an automated tool provides Web forms for buyers and pole personnel to enter new suppliers and identify existing suppliers. Further details regarding listing, approving and contacting suppliers to participate in electronic auctions is described in detail in U.S. patent application Ser. No. ______, (Attorney Docket No: 24376-8037), entitled Method And System For Electronically Communicating With Suppliers, Such As Under An Electronic Auction, filed concurrently herewith.

Rather than preapproving suppliers using manual forms, under block 316, an electronic white paper, and other forms such as secrecy agreements, are provided in a computerized network. The white paper may be provided as a Web form having appropriate fields to be completed by buyers and pole personnel. Such fields may include drop-down menus, radio buttons and other user interface tools for assisting users in rapidly completing such electronic forms.

Likewise, in block 318, rather than manually preparing an RFQ under block 228, the business entity may create an RFQ under block 328 using an electronic form. Further details regarding electronically generating an RFQ and associated tools are described in U.S. patent application Ser. No. ______ (Attorney Docket No. 24376-8027), entitled Method And System For Electronic Document Handling, Such As Requests For Quotations Under An Electronic Auction, filed concurrently herewith.

Likewise, under block 318, the qualification team may define a qualification plan by employing an electronic qualification planning form. Such an electronic qualification planning form may be similar to that for the electronic RFQ in that mandatory fields are provided, commonly used optional fields are provided, and many user interface tools are provided to permit efficient and standardized generation and completion of qualification plans.

Under block 336, the electronic RFQ is distributed electronically. For example, the auction server computer (described below) automatically generates identification (i.e., codes and passwords for pre-approved suppliers) and automatically generates e-mail messages to such suppliers to distribute such ID codes and passwords. The e-mail message may also include a hypertext link to the electronic RFQ stored on the server, as well as all associated attachments for the RFQ (e.g., drawings, charts, specifications and the like).

Under block 336, the qualification plan and testing may be performed automatically or electronically. The qualification plan and testing will typically be performed manually, but the results of such testing will be logged in an electronic Web form to be distributed among members of not only the qualification team, but also other individuals and groups noted herein. If the item does not qualify under block 138 and there is no time to retest under block 140, the buyer may renegotiate with qualified suppliers automatically under block 342. For example, under block 342, the buyer may automatically resort to a supplier who previously supplied the item, and automatically generate a new purchase order based on previous purchase orders provided to that supplier. Alternatively, after completing the auction, the runner-up supplier will be informed that it may receive the business if qualification fails for the winning supplier. Thus, under block 342, the buyer may automatically contact the runner-up supplier to place an order with this supplier. Under another alternative, the buyer may simply reopen the auction.

If the new supplier and item are qualified, but the supplier does not have a vendor number, then the server computer automatically assigns a vendor number under block 346. A “vendor number,” as generally used herein, refers to a simple key field in the MRP database that contains supplier contact information. In other words, the vendor number corresponds to a unique identifier or code associated with a record for each supplier, where the supplier record includes all relevant information regarding the supplier (e.g., bill-to address, shipping address, relevant phone numbers, fax numbers, e-mail addresses and the like). The vendor number may not be assigned until the supplier has been evaluated and determined to have met criteria such as those outlined in the white paper. Without a vendor number, automatic or repetitive purchases may not be automatically generated or flagged by the MRP system. Under an alternative embodiment, the vendor number is assigned manually. A person within the organization may verify the completeness of the required paperwork (such as the white paper, etc.). If such paperwork is complete, the person manually creates a new vendor number or supplier number in the purchasing system. Likewise, the purchasing system may or may not be linked to the MRP system.

In block 348, the MRP system or purchasing system is automatically updated with new information, such as the vendor number, information in purchase orders previously generated and the like. If multiple MRP systems exist, then an automatic conversion utility modifies received data to update the various MRP systems. Electronic data entered in one or more of the previously described Web forms is automatically input to the MRP system, e.g., as flat files. Under an alternative embodiment, the MRP and purchasing systems are manually updated with new information. Under this alternative, the MRP system requires the buyer to manually input new pricing/terms and any updates to delivery cycle or safety stock logic.

In general, the above-described blocks, with respect to method 300, automatically generate paperwork necessary under ISO procedures so that such paperwork may be quickly ready for signatures. Other processes not requiring signatures are completely superseded to thereby eliminate paper generation. Where possible, digital signatures may be provided in place of signatures on paper documents to thereby authenticate appropriate approval under ISO procedures. Data transfer from one application to another speeds the requisitioning process, such as automatically transferring information entered in a purchase order into the MRP/purchasing system under block 348. In general, Web or Internet-based tools enable multiple people to use centralized electronic forms to create, review and distribute critical information at a much higher speed than traditional paper-based systems under the above described blocks for the method 300. As shown by comparing FIG. 3B with FIG. 2B, estimated bid decisions cycle with respective blocks 240, 242, 244, and bid feedback under block 246 is reduced.

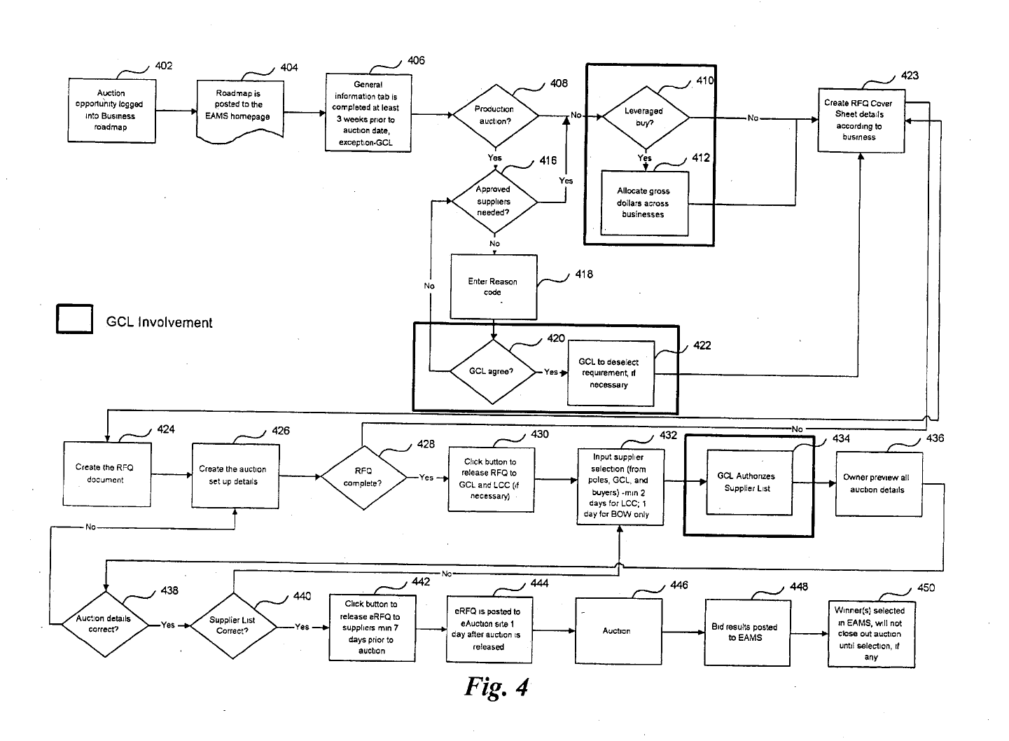

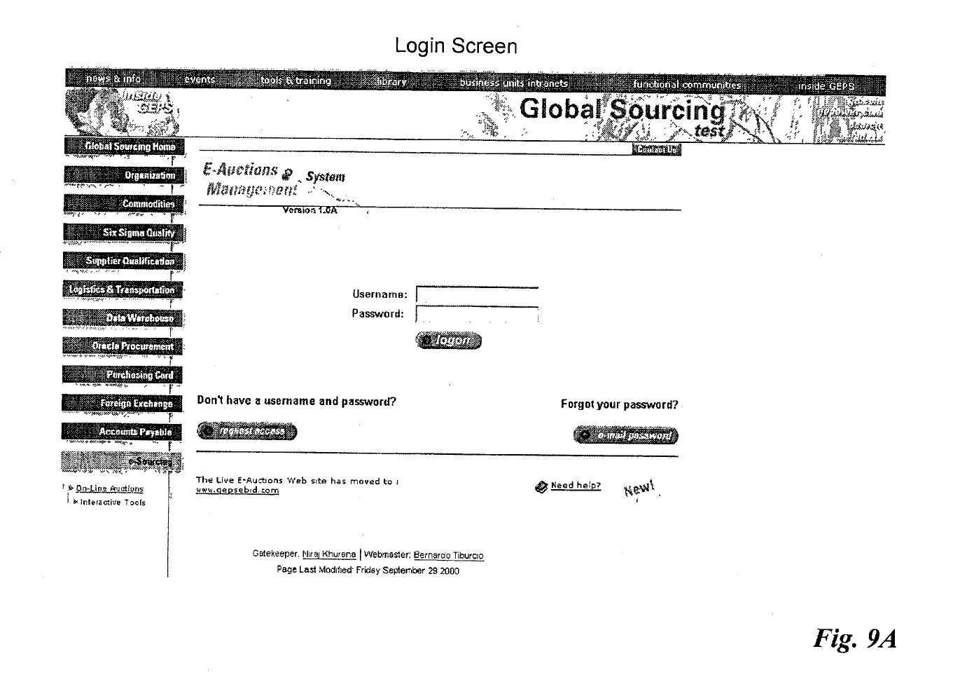

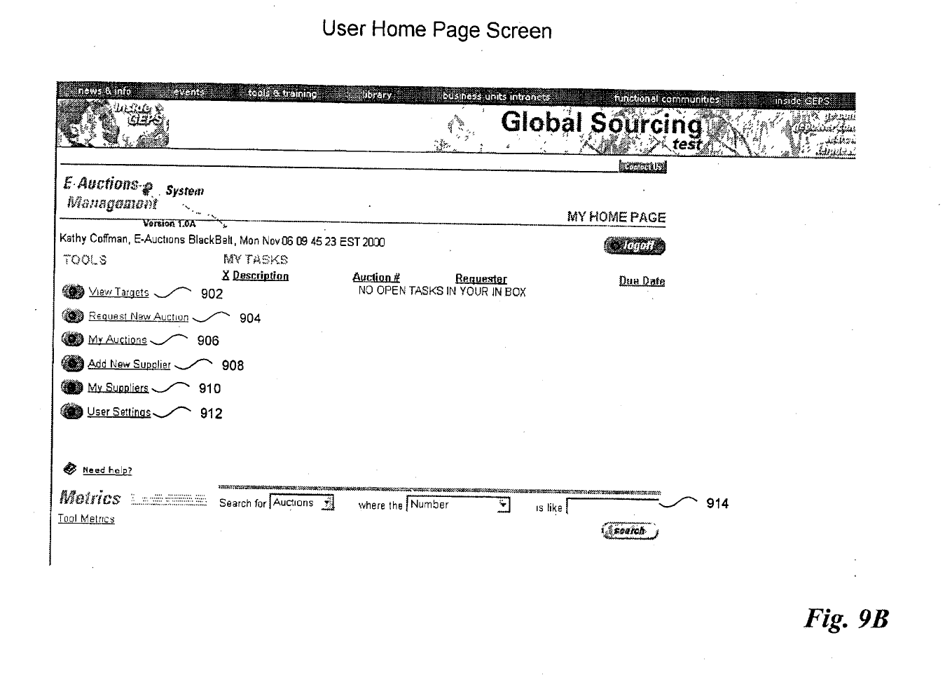

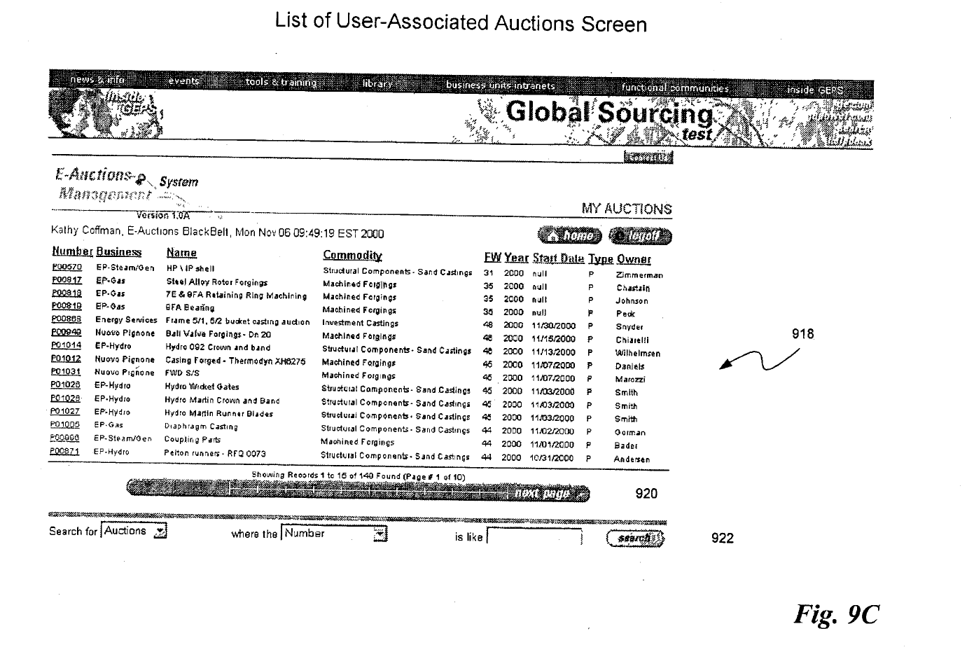

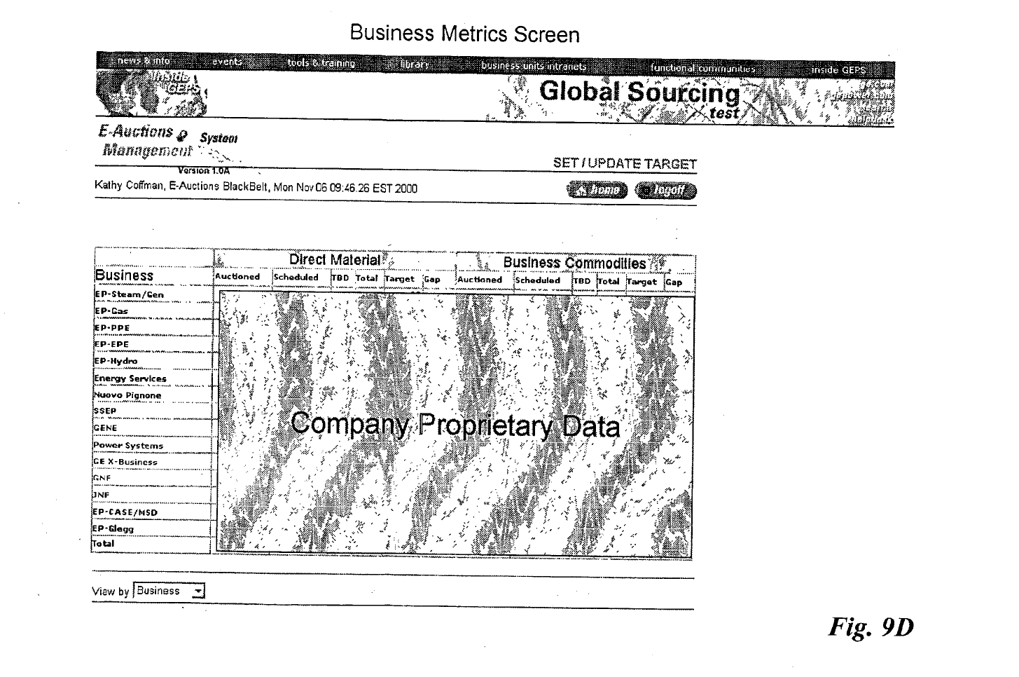

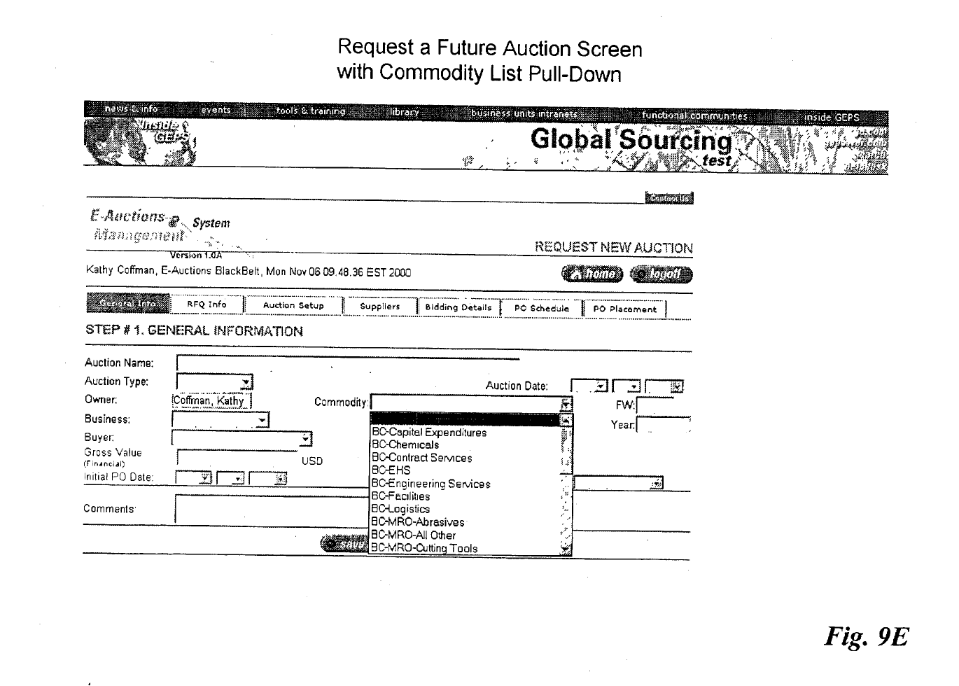

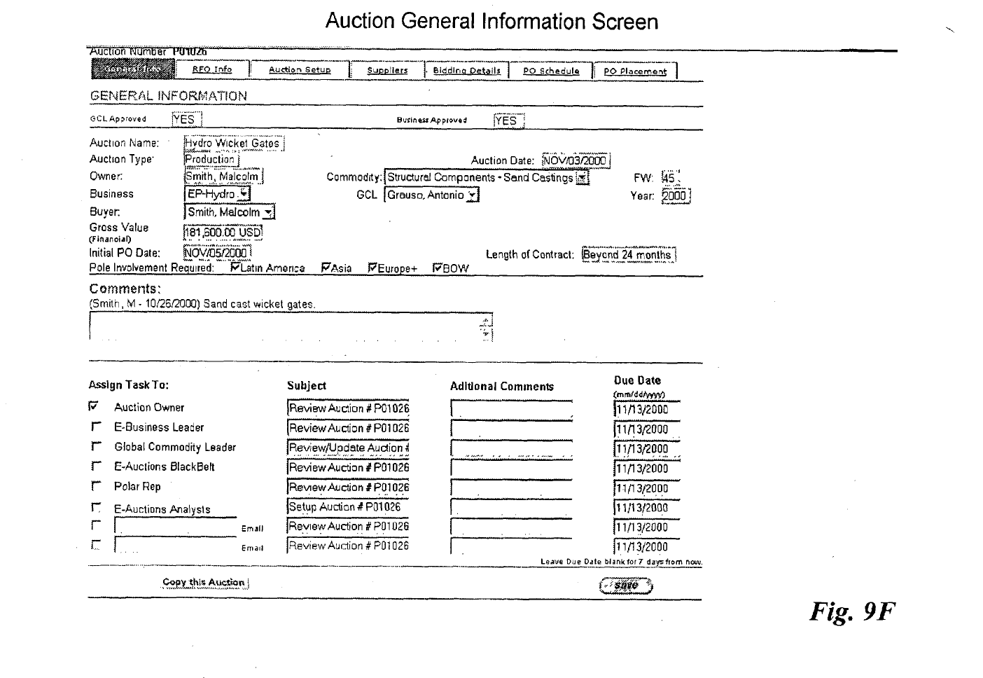

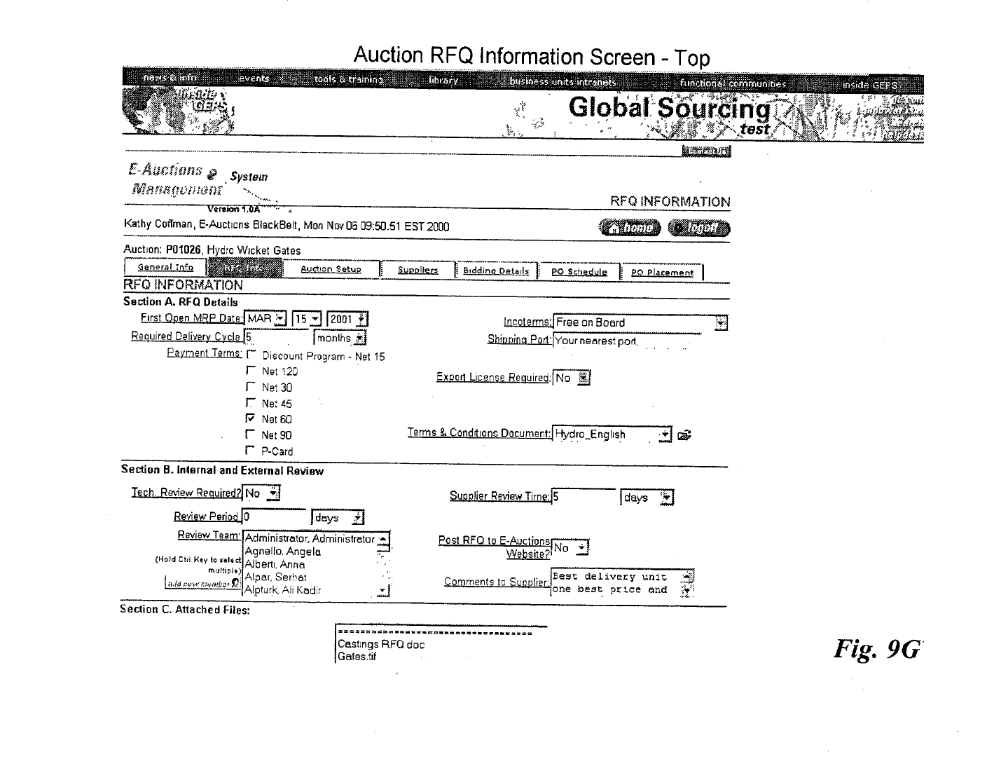

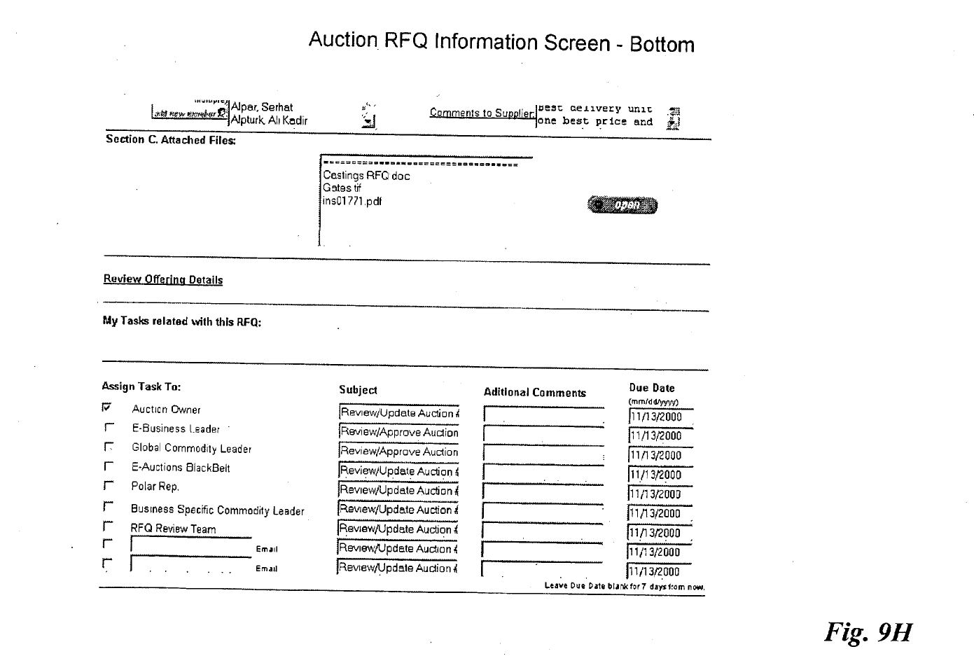

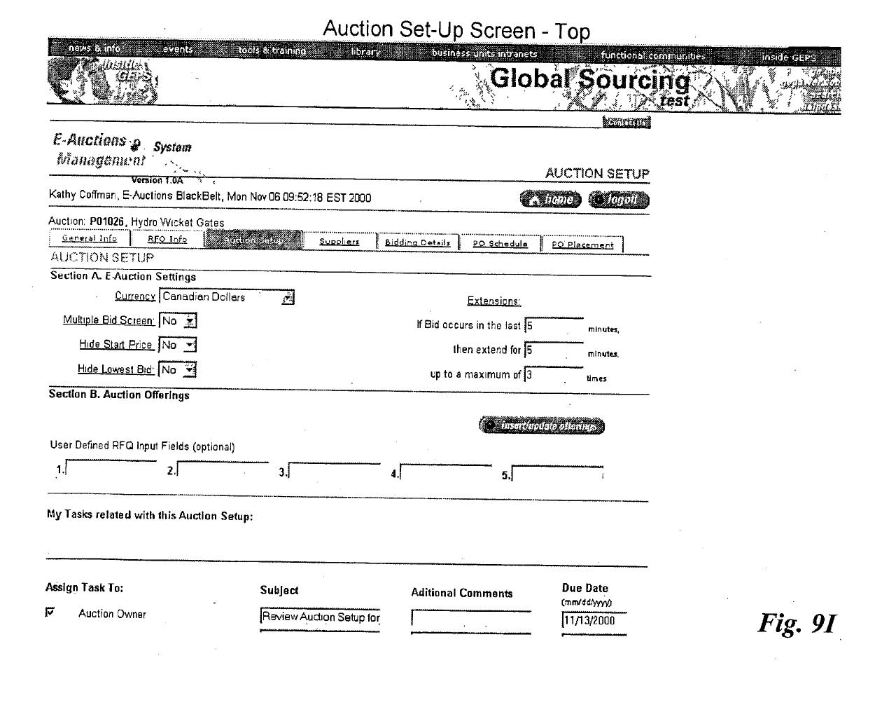

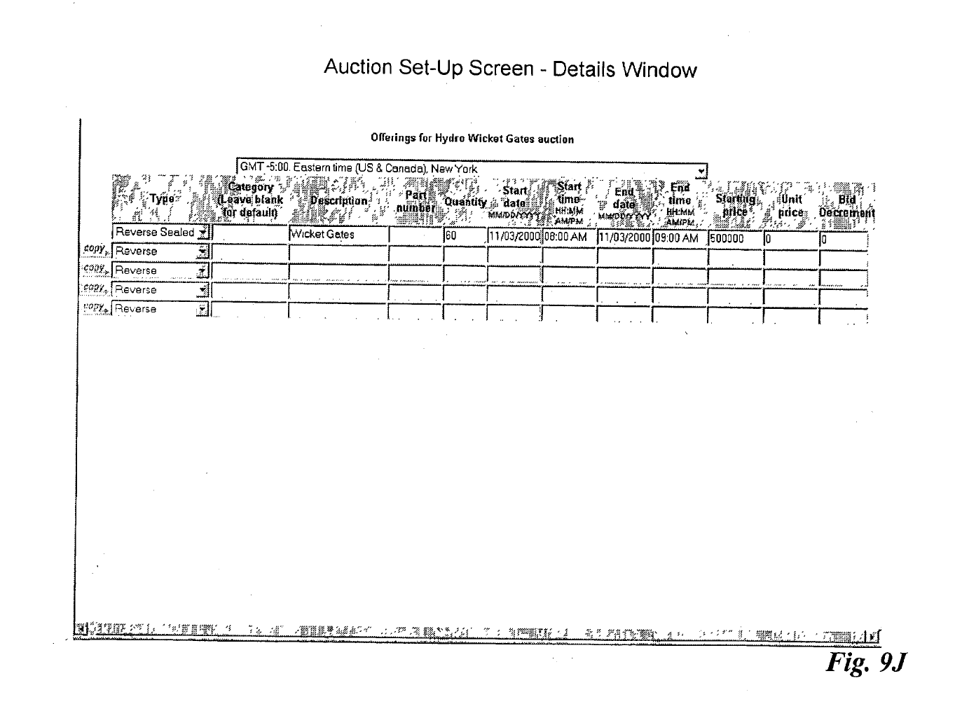

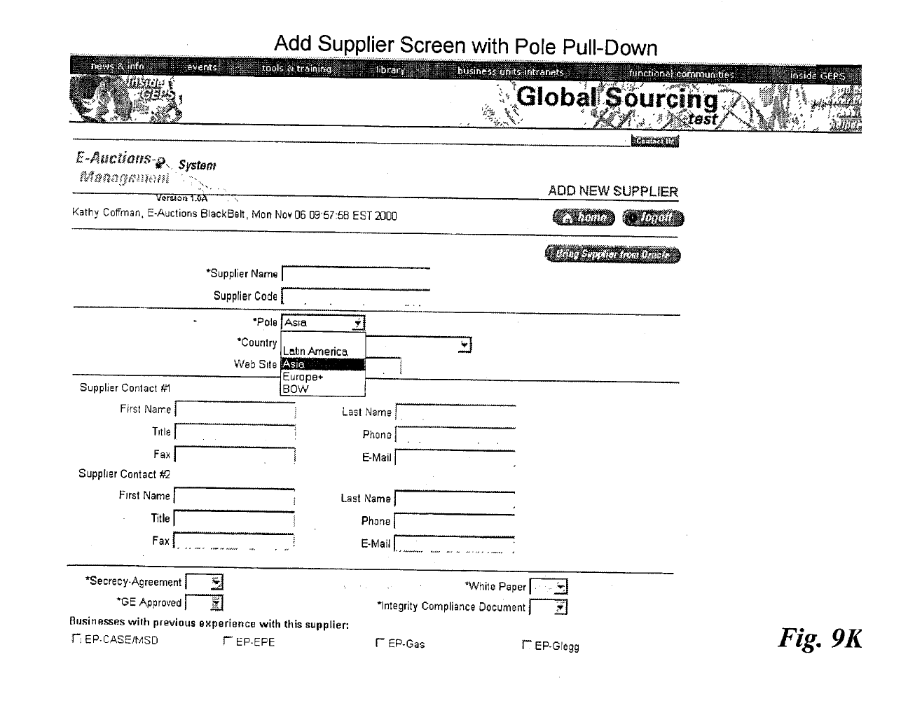

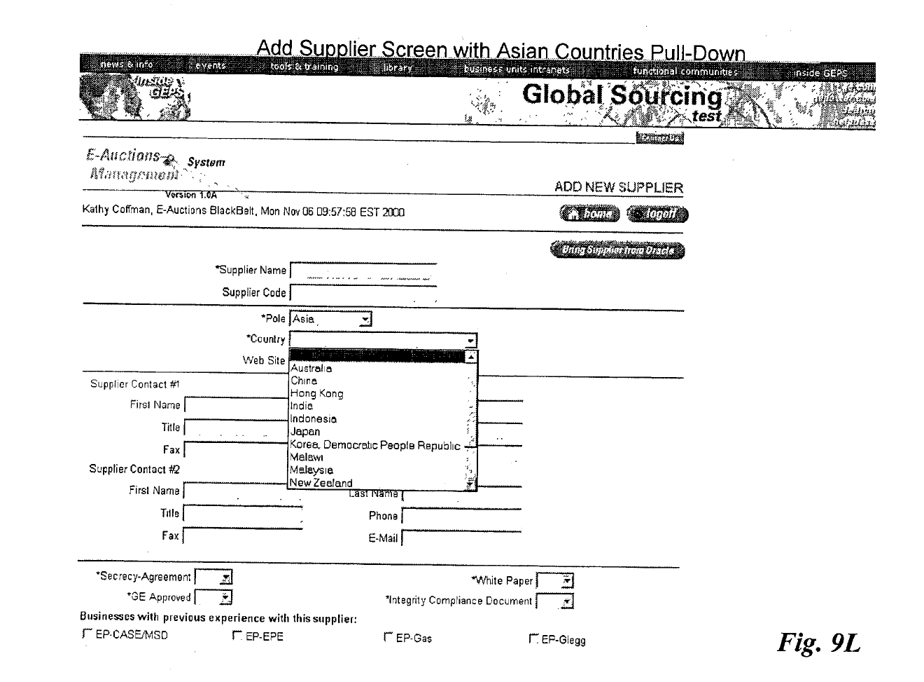

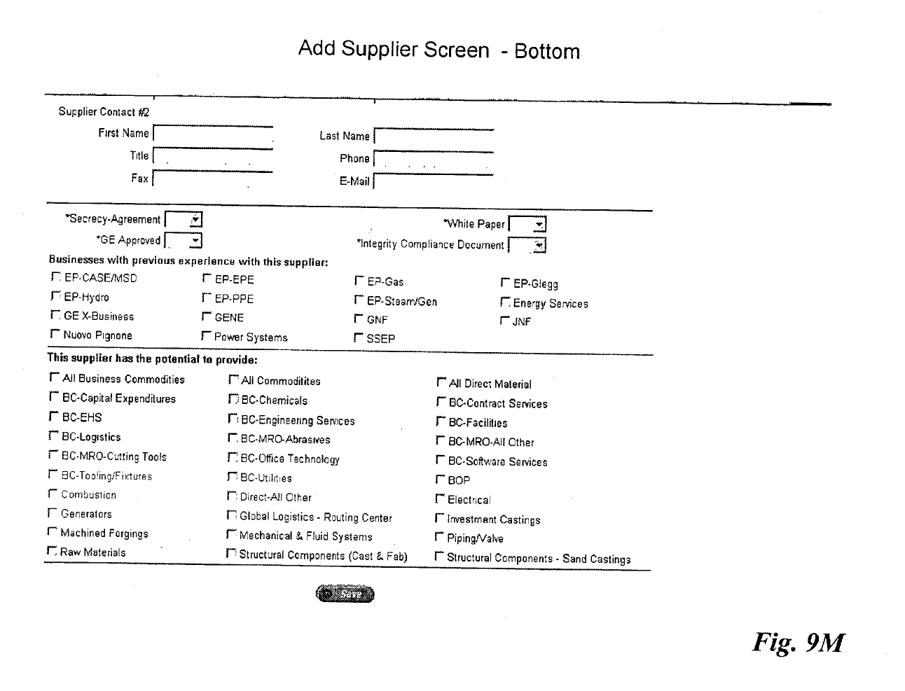

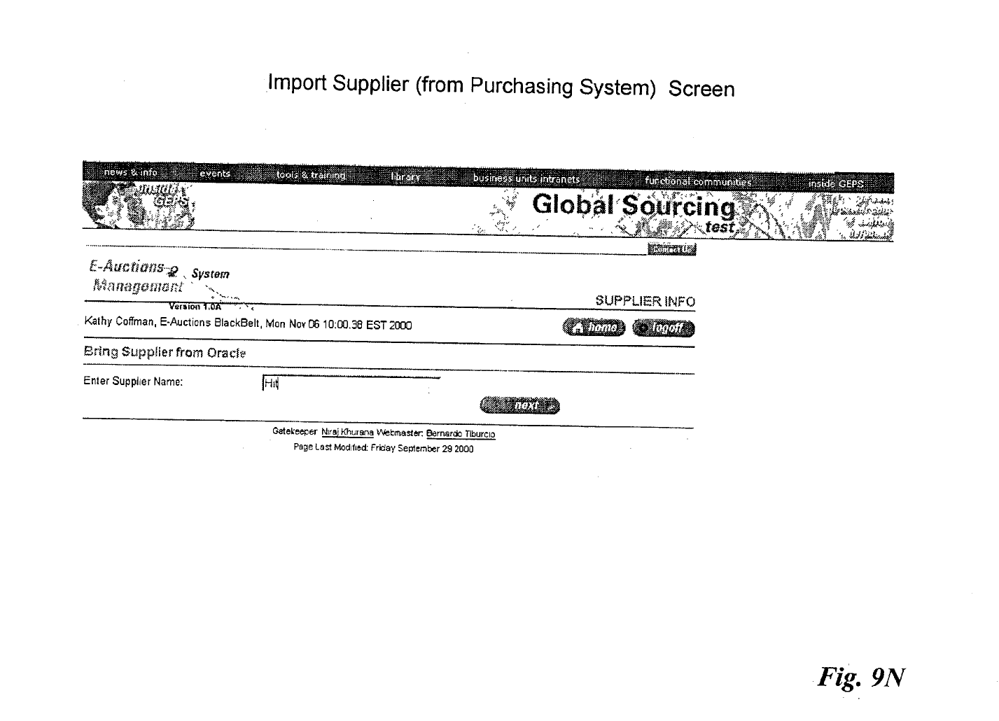

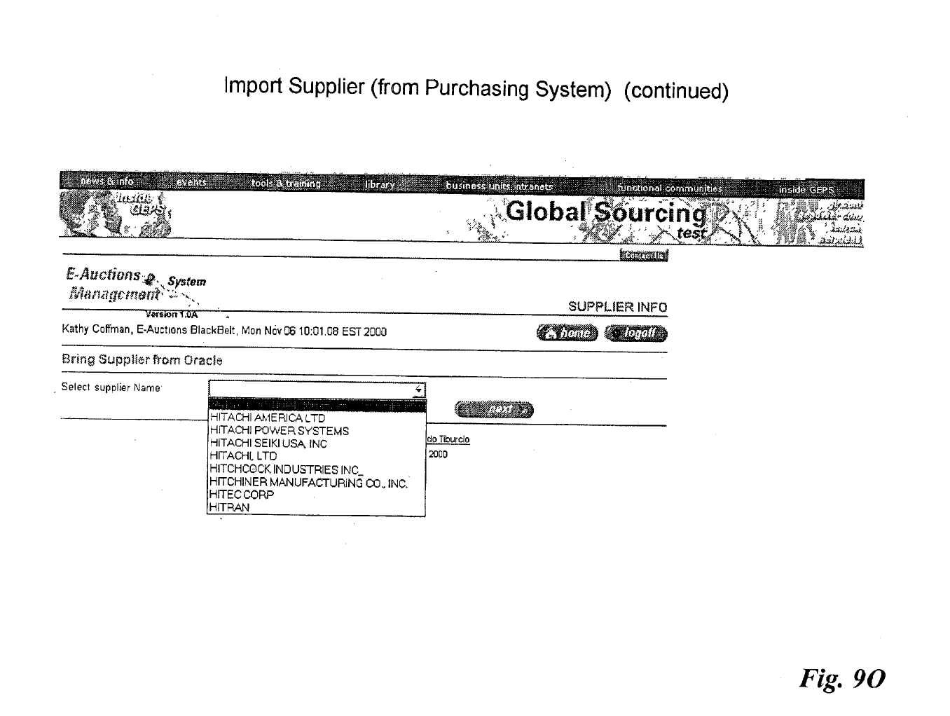

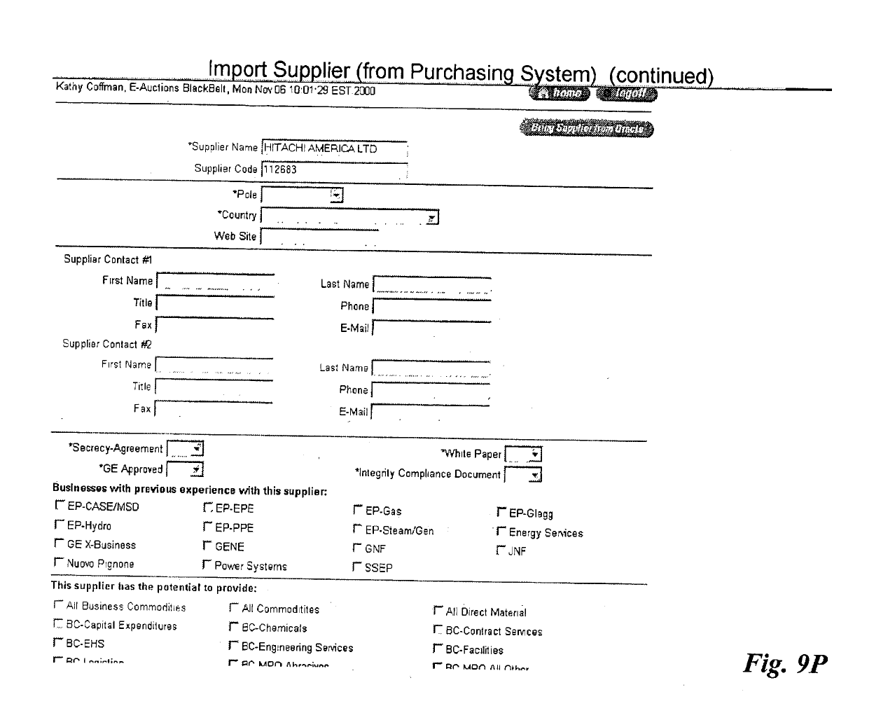

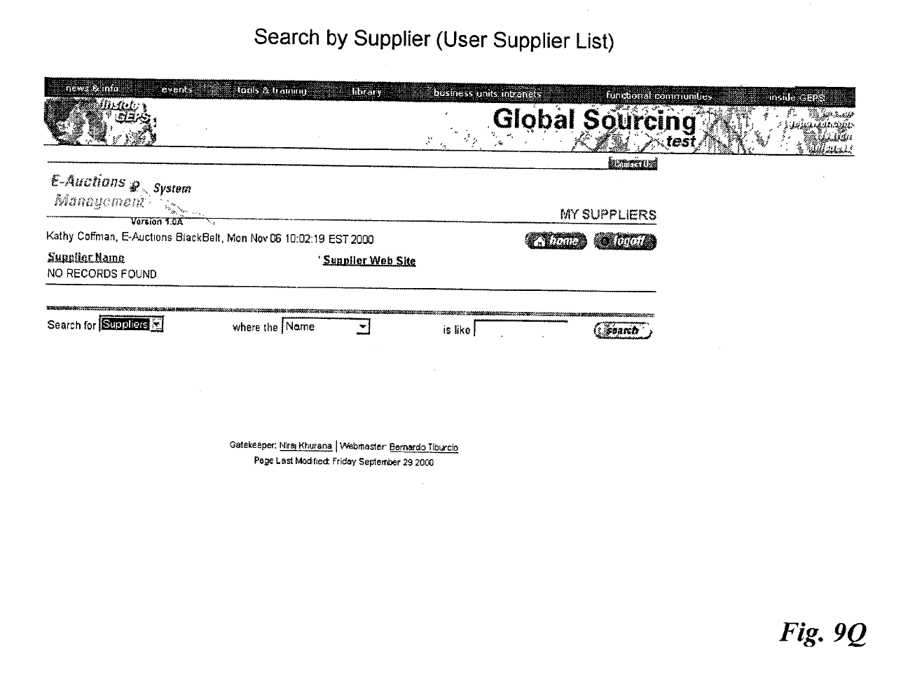

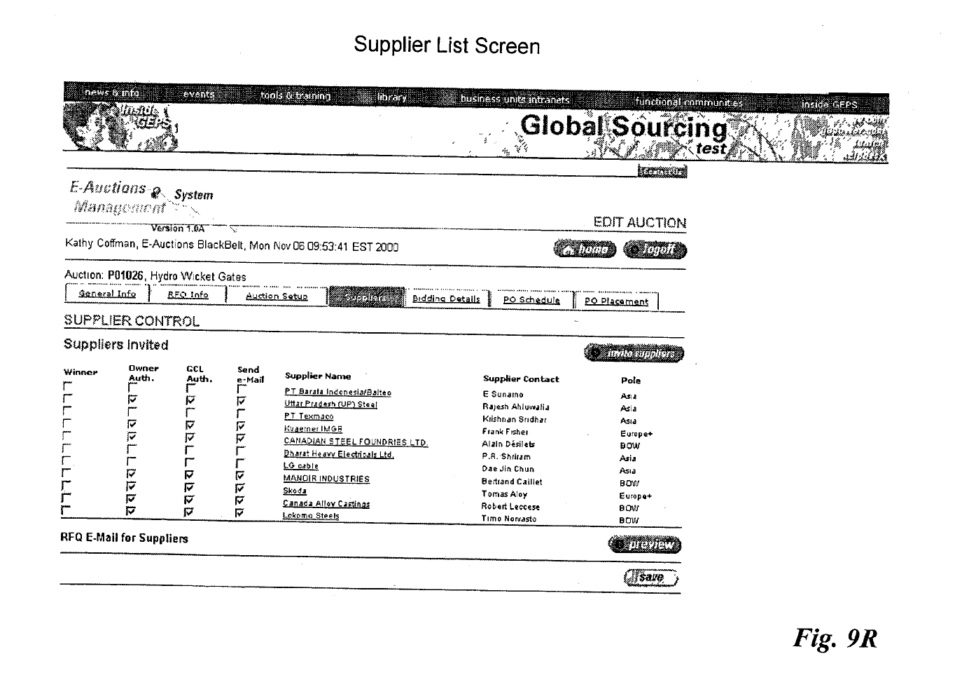

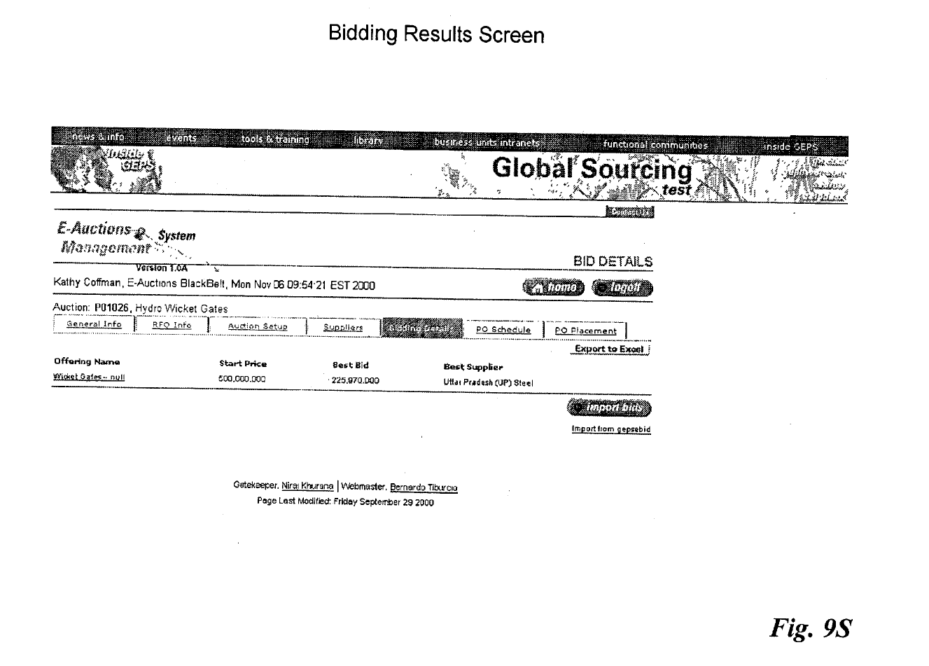

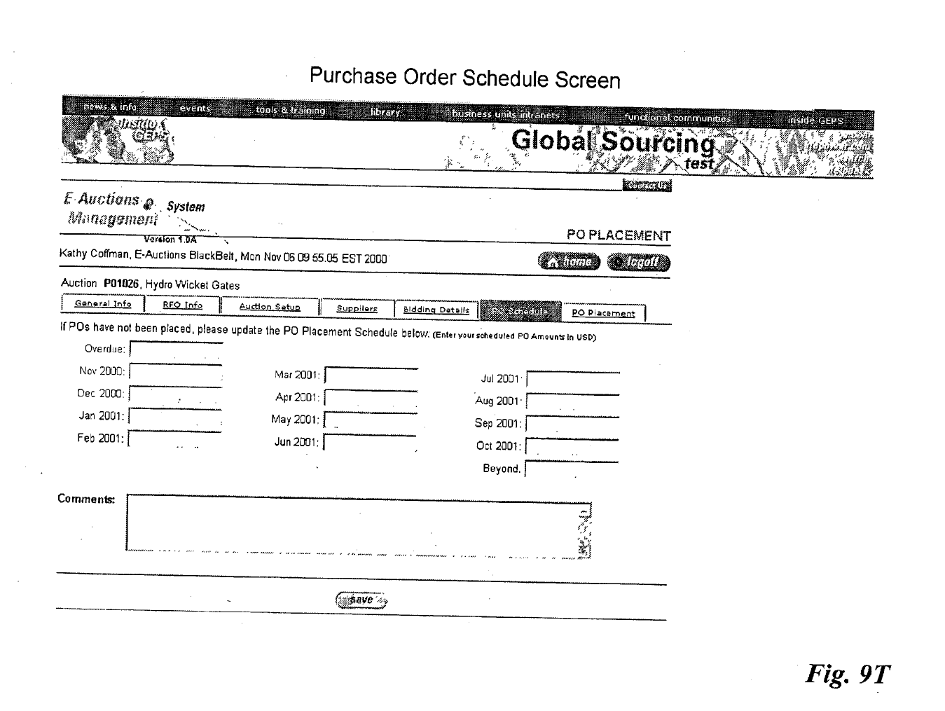

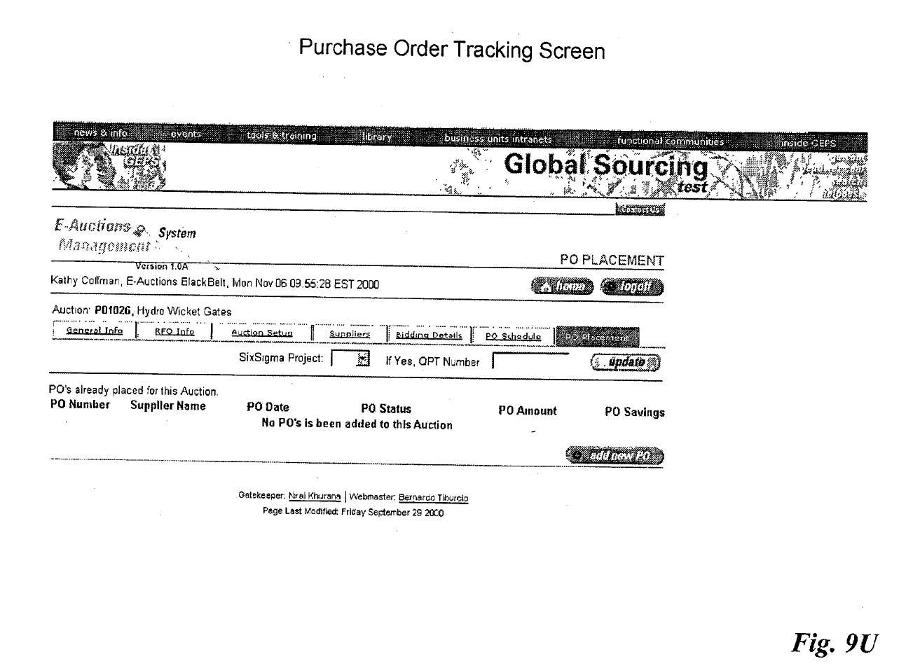

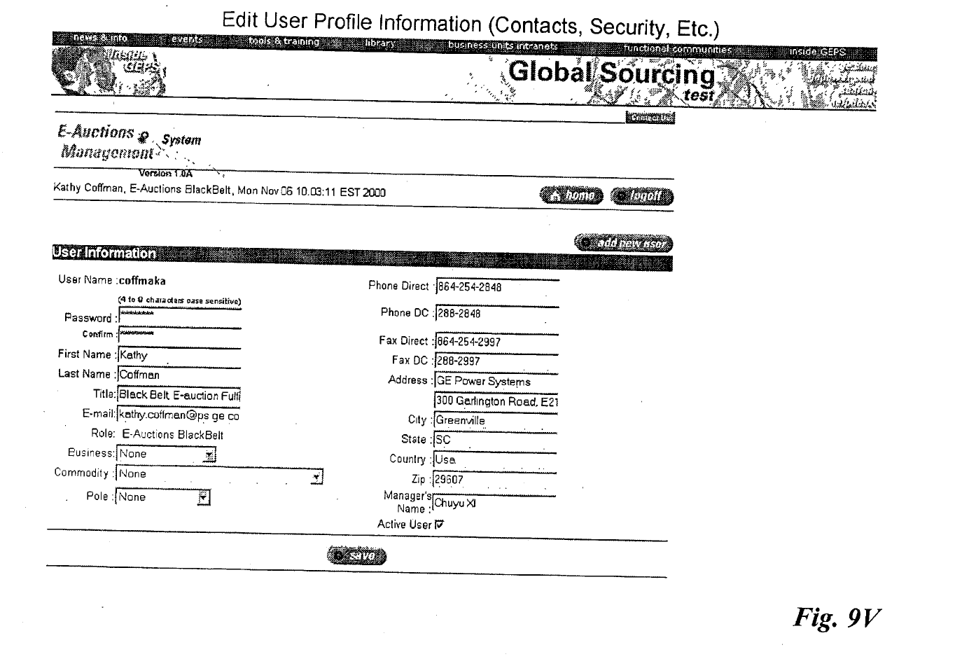

Referring to FIG. 4, further details regarding aspects of methods 200 and 300 are shown. In general, blocks 402 through 422 represent auction planning processes. Blocks 423 through 430 represent RFQ and auction detail processes. Blocks 432 through 444 represent supplier selection and invitation processes. Block 446 represents the auction process, while blocks 448 and 450 represent post-auction processes. The blocks of FIG. 4 will now be described together with suitable Web pages shown in FIGS. 9A-9V. The Web pages may be implemented in XML (Extensible Markup Language) or HTML (HyperText Markup Language) scripts that provide information to a user, and may provide facilities to receive input data, such as in the form of form fields to be filled in; drop-down menus or entries allowing one of several entries to be selected; and buttons, sliders, or other known user interface tools for receiving user input in a Web page. Of course, while certain specific ways of displaying information to users in pages are shown and described herein, those skilled in the relevant art will recognize that various other alternatives may be employed. The terms “Web page” and “page” are generally used interchangeably herein. While XML and HTML are described, various other methods of creating displayable data may be employed, such as the Wireless Access Protocol (“WAP”).

In block 402, the new auction opportunity is logged into a “business road map” or recorded for automated procurement targets. In other words, the business organization establishes certain electronic procurement goals or other business objectives, such as a percentage of each year's procurement, to be performed using electronic auctions, an annual percent reduction in cost of purchasing required items and the like. The BSL likely tracks such targets to ensure that the BSL's associated business unit is accurately tracking or exceeds a previously established business road map. As an example of logging a new auction into the business road map, a Web page form may be provided that includes fields identifying: the business requesting the new auction, the new commodity to be procured, anticipated fiscal week (“FW”), a name for the auction, a type of auction (e.g., production or qualification auction) and an estimated gross value of the auction. The commodity may be selected from a pull-down menu, or a link may be provided to a global sourcing commodity description Web page. The business may be selected from a drop-down list of separate business units within the organization.

Referring to FIG. 9A, an example of a user's login screen is shown, such as for a buyer, GCL, pole personnel, etc. The login screen of FIG. 9A is generally self-explanatory and requests the user to enter a user name and password to log on to the electronic auction system. FIG. 9B shows an example of a user's home page screen that includes several links. A “View Targets” link 902 is a hypertext link to one or more pages that view targets, such as business road map targets or business metrics (such as the page shown in FIG. 9D). A “Request New Auction” link 904 is a link to one or more pages to request and establish a new auction, such as the pages shown in FIGS. 9E through 9P. A “My Auctions” link 906 is a link to one or more pages that display auctions created by the user, or auctions for which the user is associated, such as having one or more tasks assigned to that user (e.g., the page of FIG. 9C). A “Add New Supplier” link 908 is a link to one or more pages to permit the user to add suppliers to an auction or list of existing suppliers, such as the pages shown in FIGS. 9K through 9M. A “My Suppliers” link 910 is a link to one or more pages that list suppliers created or otherwise associated with the user, such as the page of FIG. 9Q. A “User Settings” link 912 links to one or more pages to permit the user to adjust user settings with respect to the electronic auction, web interface, or other functions and features of the electronic system described herein (e.g., the page of FIG. 9V). The home page screen also allows a user to search business metrics in a section 914.

Under block 402, a user or buyer enters a new auction opportunity under a Web page form, such as the Web page of FIG. 9E. As shown in FIG. 9E, the Web page includes a drop-down list of commodities 916, such as “BC-Chemicals,” where “BC” refers to business commodities (indirect material). Other fields to be completed by a user to enter a new auction opportunity as shown in FIG. 9B are self-explanatory.

In block 404, the business road map is posted to an Electronic Auction Management System (“EAMS”) home page. Thus, the home page for the EAMS posts target levels for electronic procurement under aspects of the system described herein. The EAMS is another word for the electronic auction system described in detail herein. In one embodiment, the EAMS is a tool set that prepares electronic RFQs, electronic qualification plans, distributes RFQs and associated materials, compiles auction supplier lists, facilitates planning to place purchase orders based on auction results, and facilitates report generation of electronic auction activity. Referring to FIG. 9C, an example of a Web page listing auctions associated with a user is shown. A central portion of the screen 918 includes a table. The table includes a first “Number” column identifying auctions by number (such as purchase order number), a second “Business” column identifying the separate business unit within the business, a third “Name” column providing a common name for the auction, and a fourth “Commodity” column that identifies the commodity involved in the auction. The table also includes the year in which the auction was conducted, the start date for the auction, the type of auction (production or qualification auction), and the last name of the auction owner. The Web page of FIG. 9C also includes a slider bar 920 that allows the user to effectively scroll through a long list of auctions. Alternatively, the user may employ a search portion 922 that allows the user to search for auctions based on various criteria, such as number, business, name, commodity or other columns in the table described above.

Under block 404, the new auction opportunity may appear not only on the list of auctions in FIG. 9C, but also listed on a business metrics screen, such as that shown in FIG. 9D. Such a business metric screen may list both direct material and business commodities with respect to various business units within the organization. (Company proprietary data is obscured in FIG. 9D.)

In block 406, a general information tab or screen is completed at least three weeks before the auction date. The Web page of FIG. 9F provides an example of a general information screen for a new auction. The general information screen provides general information regarding the auction, such as the following: an automatically entered date stamp indicating the creation date of the actual request; a name and type of auction; an owner of the auction (which can be automatically entered based on the person logged into the system and currently entering information); a buyer's name and phone number (such as selected from a drop-down menu that automatically fills in appropriate phone numbers and other information from a global address book); a date for the auction (e.g., a minimum of 14 calendar days from the creation date); whether leveraging with other businesses is possible (such as via a pull-down menu or checkbox); one or more entries of gross financial volume with respect to the separate business units; gross financial value; initial date a purchase order will be issued; and whether pole personnel may be involved for qualified suppliers so that low cost countries may participate (and if not, a reason for excluding them). Other fields to be entered by the buyer when entering general information regarding a new auction are shown in FIG. 9F, including assigning tasks to various individuals within the organization to execute the auction. The GCL may make an exception to the requirements under block 406.

In block 408, the system determines whether the auction is a production auction based on the buyer's previous input to the screen of FIG. 9F (identifying the type of auction) A “production auction,” as generally used herein, refers to an electronic auction where no qualifications are necessary for suppliers. For example, any item that does not require particular qualifications, such as shop rags or batteries, or those for which suppliers are already qualified, may qualify as a production auction. Alternatively, the auction may be a “qualification” auction that does require qualifying the items. If the auction is not a production auction, then the GCL determines whether the auction is a leveraged purchase. If so, then the GCL (and possibly the buyer) allocate gross dollars across two or more business units. Thus, under blocks 410 and 412, the method notifies the GCL (such as electronically forwarding the completed general information page of FIG. 9F), and the GCL may attempt to identify additional leverage across business units to produce better auction results for the business organization overall.

If the auction is a production auction, then under block 416, the system determines whether qualified Low Cost Country (“LCC”) suppliers are acceptable or needed, based on the buyer's previous input to the page of FIG. 9F (such as identifying pole involvement). An LCC has been identified by the business organization as providing inexpensive raw materials, inexpensive labor and/or other benefits. As a default, LCC's can participate in a production auction. If approved LCC supplies are needed, then the method proceeds to block 410. If not, then the buyer enters a “reason code” (not shown) under block 418. A “reason code,” as generally used herein, refers to a reason why an LCC cannot participate in an auction. Such reasons include: that no qualified LCC supplier is known, that governmental restrictions apply to a certain country (e.g., export control issues, in which case the name of a country must be provided by the buyer), that the government requires a percentage of a purchase to be in a certain country, that the item to be purchased is perishable (e.g., natural gas), cycle time requirements (e.g., a quick purchase and delivery of the item is required), specific CTQ issues (e.g., only highest quality preapproved suppliers may be employed), certain business global strategy, and other reasons.

A Web page for initializing or approving an auction (not shown) includes a drop-down menu field to identify these and other reason codes. As a result, the business can then track statistics and other data regarding why countries cannot participate in auctions, and use such data to possibly help correct such problems (for example, employing lobbying efforts to relax export control regulations). If the GCL does not agree under block 420, the process loops back to block 416. If the GCL does agree, then in block 422 the GCL deselects requirements, if necessary. In other words, if the GCL agrees with the buyer that the reason code is sufficient or adequate, then the GCL deselects the default that LCC's cannot participate (thereby excluding them).

In general, the GCL may be required to provide approval for any new auctions. Such approval may be provided as a small application (“applet”) or macro on a submitted, proposed electronic auction form, whereby clicking a button invokes the applet to generate a pop-up window or separate frame (not shown) that requests the appropriate GCL to input a password. After entering the password, the GCL may choose several options, such as approving the auction “as is” with no leveraging opportunity from other business units, holding or delaying the auction for a certain time period to permit additional leverage by accumulating additional volume for the commodity, requesting clarifications or amendments to the proposed auction, approving amendments to the auction, and/or deselecting involvement of one or more poles.

Following blocks 422, 410 or 412, the business unit and/or buyer creates an RFQ cover sheet containing details with respect to the business in block 423. FIGS. 9G and 9H show an example of an RFQ cover sheet Web page. As shown in these figures, the RFQ coversheet may include the following items selectable from the Web page form or readily input thereto: project timing (including a first open MRP date and a required delivery cycle); transportation and delivery requirements (e.g., North and South American locations, export and international locations, and/or where title transfer occurs, such as from a drop-down menu between the buyers dock or seller's dock); terns and conditions, including standard business terms or Incoterms, as well as payment terns and any special conditions; and a list of any attached files for the RFQ. The RFQ cover sheet page may also include information regarding internal and external review, such as whether a review is required, the review period, the review team, the time period for a supplier to review, and the like. While not shown in FIG. 9G or 9H, the RFQ cover sheet page may include a summary of the items to be auctioned, definitions of any terms, and detailed product descriptions, including quality records that may be required. After creating the RFQ cover sheet, the business unit creates the RFQ document in block 424.

In block 426, the buyer creates the auction setup details by entering details regarding the auction into the auction system. FIGS. 9I and 9J are examples of Web page forms which permit the buyer to readily input auction setup information. The Web page forms may include the following items, selectable from the form or readily input thereto: a currency in which purchase orders will be issued or a currency in which all bids are to be submitted; an auction duration from one date and time to another date and time (which may be automatically input to the Web form based on prior entries to the system); any deviations from specifications and/or terms and conditions within a comments section of a bidding screen; and/or a contact name, address, telephone number and email address of an auction owner to which questions concerning the RFQ are to be directed. The auction setup page may also permit the auction owner or buyer to provide for automatic extensions to the duration of the auction. For example, if a bid occurs during the last five minutes of the scheduled duration of the auction, then the auction is extended another five minutes. Such an extension can occur up to a maximum of three times. Additional fields may be provided, such as those shown in FIGS. 9I and 9J. Under an alternative embodiment, data may have been generated in other formats (such as within a spreadsheet application) which, under block 426, may be uploaded into a Web-based format (e.g., HTML or XML) where the auction system is an electronic Web-based auction system as described herein.

In block 428, if the RFQ is not complete, the process loops back to block 423. If the RFQ is complete, then in block 430, the buyer or business unit click a button on the electronic RFQ (under method 300) to release the RFQ to the GCL and pole personnel associated with the LCC (if necessary). In other words, once the RFQ and auction setup are complete, the auction owner must preview and click a button or box to release the RFQ to appropriate individuals. Once the release happens, under the embodiment of the method 300, the system automatically generates tasks for appropriate individuals, such as the pole personnel or other LCC representatives (if necessary), and to the GCL. For example, the system generates electronic messages (such as email messages) stating that an RFQ for the auction (identified by name and date) has been released.

In block 432, the buyer and pole personnel input supplier selection. The GCL may also identify suppliers. A minimum of two days is required for LCCs, but one day for the balance of the world (“BOW”). In general, the minimum time set takes into consideration how long the supplier selection process should take based on the intended scope of the auction. FIGS. 9K through 9R show examples of Web page screens for adding suppliers. The fields in these pages are generally self-explanatory. FIG. 9K shows an add supplier screen with a drop-down menu of geographic poles and the Asian pole selected. FIG. 9L shows an add supplier screen with a pull-down menu of Asian countries associated with the selected Asian pole. FIG. 9N shows an example of a bottom portion for the Web pages of FIGS. 9K and 9L. As shown in FIG. 9M, the buyer may identify businesses that previously had had experience with a particular supplier and identify that the supplier has potential to provide any of the listed commodities.

Under the electronic system (such as that under method 300), the system may allow buyers, pole personnel and others to search for suppliers previously entered into the system by using the supplier's commonly known name (e.g., IBM instead of International Business Machines). For example, the Web page of FIG. 9N allows the buyer to enter a supplier name, or as shown in FIG. 9O, select a supplier name from a drop-down menu. FIG. 9P shows an example of a retrieved supplier record imported from, for example, a purchasing system. Alternatively, the buyer or other user may have a personal list of preferred suppliers and may retrieve the records of such suppliers. In FIG. 9Q an example of the Web page that permits a user to search and retrieve records for such a personal list of suppliers is shown. FIG. 9R shows an example of a Web page listing suppliers to be included in an auction. As shown, suppliers are identified by name (with associated link to the supplier's record), a supplier contact and the pole associated with the supplier. The owner of the auction and the GCL may separately authorize the supplier for participation in the auction.

In general, the supplier list may be separated into three sections: qualified to bid, proposed to bid and accepted for bidding. “Qualified to bid” suppliers are those suppliers the buyer or GCL has previously identified as being qualified to manufacture the item requested (for production auctions only). “Proposed to bid” suppliers are suppliers offered by pole GCL or other personnel to be considered for input to the auction. “Accepted for bidding” suppliers are those suppliers on an official list of suppliers who may be included in an auction but who must later be qualified. The GCL, e.g., may have the ability to accept suppliers for inclusion on the list. If the GCL determines that a supplier is not to be put on the list, then the GCL may input a reason, such as selecting a reason code from a drop-down list of codes in a Web page form (not shown). Such reason codes may include the following: the supplier's capability to supply the item was not validated, the supplier exhibited unacceptable prior performance on quality and/or delivery, the supplier has no domestic distribution or service organization, and/or the supplier did not meet pre-requirements (such as those detailed in the white paper). Thus, in block 434, the GCL may be the person who authorizes the list of suppliers.

After the time expires for inputting suppliers (one or two days, as noted above), the auction owner may preview the electronic auction before it is released to suppliers. For example, under an electronic auction system, the system may automatically send an email or other notification to the auction owner stating, for, example, that the supplier selection is complete, and asking the auction owner to verify that all auction settings are complete and to release the auction invitation to the selected suppliers. The system may automatically present a summary page (not shown) that details all auction setting information and a supplier list for the auction owner so that auction details may be readily reviewed by the auction owner. If all settings are in order, the auction owner may click on a box or virtual button on the summary page to release the electronic RFQ to identified suppliers. Thus, under block 436, the auction owner previews all auction details and determines, under block 438, whether the auction details are correct. If not, the process loops back to block 426. If the details are correct, then in block 440, the auction owner, buyer, GCL or other individual determines whether the supplier list is correct. If not, the process loops back to block 432. If the supplier list is correct, then in block 442, the auction owner clicks a button (under method 300) to release the electronic RFQ to the suppliers a minimum of seven days (or other suitable time limit) before the auction.

In block 444, the electronic RFQ is posted to the electronic auction site, e.g., one day after the auction is released. In block 446, the auction is conducted, and in block 448, bid results are posted to the auction system. FIG. 9S shows an example of a bidding results screen that identifies the winning or best supplier. As shown in FIG. 9S, the name of the auction is provided (“Wicket Gates”), which includes a link to Web pages providing detailed information regarding the auction. Also shown are a start price, best bid, and name of the winning supplier. A button “Export To Excel” allows the user to export the data to a spreadsheet, such as for tracking business metrics. An “import bids” button permits the system to import all bids received during an auction from an auction component to a reporting and Web server component. Thus, under one embodiment, the auction component may be separate from an intranet Web server for providing the Web page screens described herein. This button permits bid history to migrate from an auction server (such as a separate MOIA auction server outside of the business unit intranet) to the business unit's server for download and manipulation.

In block 450, the winner is selected in the auction system. The system will not close out the auction until a selection is made, if any. Under an electronic auction system, the system automatically imports bids received from suppliers and permits the auction owner (such as the buyer) to denote the supplier or suppliers who will receive a purchase order and the dollar amount per supplier as a portion of the total gross financial value previously identified above. FIG. 9T is an example of a Web page for scheduling one or more purchase orders with the winning supplier. Under one embodiment, the MRP or purchasing system may then automatically generate purchase orders and electronically transmit, fax, mail or otherwise deliver such purchase orders to the winning supplier. As noted above, the buyer may have previously prepared a purchase order, which has been approved, but simply needed a supplier name and address to be input thereto. Now that a winning supplier has been identified, the buyer may simply input the name and address of the supplier into the previously generated purchase order to quickly and efficiently place the first order, and other orders as scheduled under the page of FIG. 9T. FIG. 9U provides a screen for permitting the buyer to track purchase orders placed based on a particular auction (none of which are shown in the Figure).

Under one alternative embodiment, the purchasing system is not linked to the auction system, and thus the system does not automatically generate purchase orders according to a schedule. A purchase order schedule helps the business plan finances (such as receipts) and may be useful in transacting purchases. The purchasing system may automatically generate purchase orders for manually entered reordered logic. The buyer or other individual may manually update purchase price, supplier, reorder quantity, delivery cycle, etc., and the purchasing system may subsequently generate purchase orders automatically to meet those requirements and maintain appropriate stock levels for the item previously auctioned. Thus, under this embodiment, the purchasing system and an inventory management system may be one combined system.

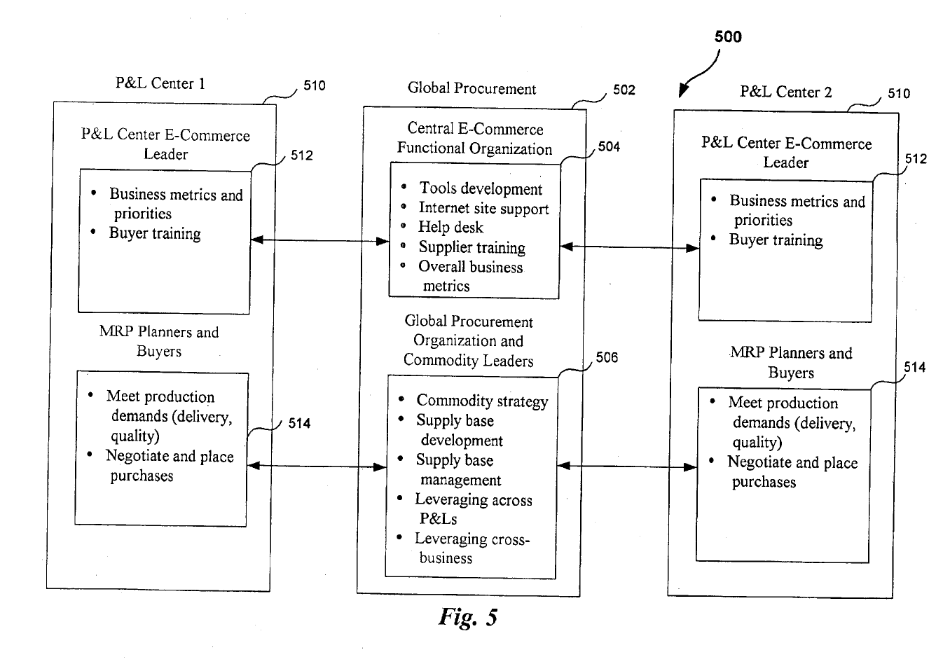

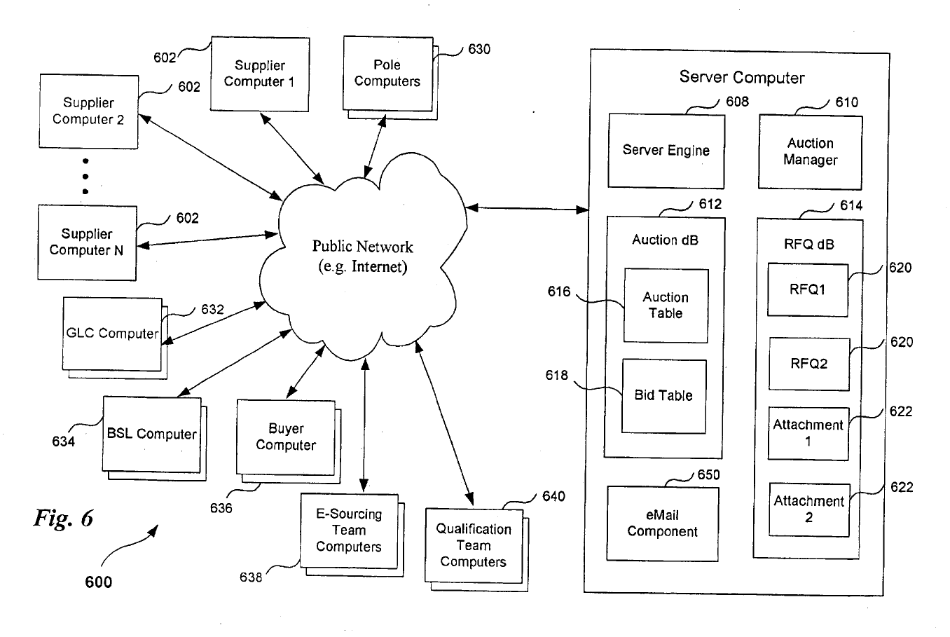

Further details regarding specific aspects of the above method and further details regarding Web page or other electronic interfaces for an electronic procurement system may be found in the above-referenced patent applications. So that the process of implementing such an electronic system may be appreciated, organizational structures, responsibilities and communication flow will now be described with respect to FIGS. 5, 7 and 8. Additionally, a suitable hardware platform for implementing an electronic auction will be described with respect to FIG. 6.

Referring to FIG. 5, an organizational system 500 is shown having a central global procurement organization 502 comprising a central e-commerce functional organization 504 and global procurement organization and commodity leaders 506. The central e-commerce functional organization is responsible for developing tools, such as the Web-based tools described herein, and creating and/or providing an Internet site to facilitate e-commerce (such as under the auction model described herein). The central e-commerce functional organization also provides a help desk (for both buyers and suppliers as well as others), supplier training to facilitate participation in electronic auctions or other c-commerce models, and logging and tracking overall business metrics for e-commerce procurement.

The global procurement organization and commodity leaders identify and fulfill commodity strategies, such as an initiative by the business organization to outsource 70% of the engineering to low cost countries, with 70% of that being to offshore low cost country organizations (e.g., engineers physically located in such offshore countries). The global procurement organization and commodity leaders provide supply base development and supply base management by identifying potential new suppliers, maintaining harmonious relationships with existing suppliers and the like. The global procurement organization and commodity leaders also leverage across separate business units and provide cross-business leveraging as described herein.

The global procurement organization interfaces with separate business units, such as profit and loss (“P&L”) centers 1 and 2 (identified by reference numeral 510). Each P&L center includes at least one e-commerce leader 512 and MRP planners and buyers 514. The P&L center e-commerce leaders establish and track business metrics and priorities, such as under the business road map described herein. Additionally, the P&L e-commerce leader provides buyer training to permit all buyers to employ the electronic auction system described herein, or other electronic commerce systems. The MRP planners and buyers establish and strive to meet production demands, such as delivery, quantity and quality demands of the P&L center. Additionally, the MRP planners and buyers negotiate and place purchases with suppliers under the electronic system described herein, or other e-commerce models.

Referring to FIG. 6, a block diagram illustrating an example of components of the electronic auction system described above is shown. One or more client or supplier computers 602 and a server computer 604 are interconnected via a public network such as the Internet 106. These computers may include a central processing unit, memory, input devices (e.g., keyboard and pointing devices), output devices (e.g., display devices and printers) and storage devices (e.g., optical and/or magnetic disk drives), all not shown in FIG. 6, but well known to those skilled in the relevant art. The memory and storage devices are computer-readable media containing computer instructions that implement the auction system. The supplier computers may use a browser to access the Web pages via the Internet.

The server computer implements the auction system. The server computer system includes a server engine 608, an auction manager 610, an auction database 612 and an RFQ database 614. The server engine receives requests for resources (e.g., Web pages) via the Internet and coordinates the generation and transmission of the resources. The auction manager coordinates the conducting of the auctions. The auction manager stores auction listings and bidding histories in the auction database. When an auction closes, the auction manager supplies the supplier's submitted bids to the individual conducting the auction, and may provide a listing of bids in increasing order of price. The auction database includes an auction table 616 and a bid table 618. The auction table includes an entry for each auction conducted by various buyers within the business organization. The bid table includes an entry for each bid that was placed by a supplier during each auction, with corresponding indicators or links to the appropriate auction in the auction table.

The RFQ database includes one or more electronically generated RFQ's 620 (two of which are shown in FIG. 6) and associated electronic attachments 622. While shown in FIG. 6 as stored in the RFQ database of the server computer, attachments (or other documents such as electronic RFQ's) may be stored on another computer. The server computer may, of course, store additional documents, such as electronic qualification plans, electronic white papers and other supplier approval documentation, and other electronic documents or forms described herein.

The server computer is also intercoupled with other computers associated with the business organization, such as one or more pole computers 630, GCL computer 632, BSL computers 634, buyer computers 636, e-sourcing team computers 638 and qualification team computers 640. All of such computers are similar to the supplier computers described above. Additionally, such computers may communicate via electronic mail. Thus, the server computer may include an electronic mail component 650 to facilitate electronic communication between such computers. While one server computer is generally shown in FIG. 6, more than one server computer may, of course, be employed, such as a server computer for performing auctions (and thus employing the auction manager and auction database), another server computer for providing electronic mail, purchasing, MRP and/or other functions described herein, and a third Web server computer for handling some or all of the various electronic documents and pages described herein. While wired connections are shown, the various computers may be connected via wireless connections. The invention can be embodied in a special purpose computer or data processor specifically programmed, configured or constructed to perform one or more of the computer-executable functions described in detail herein. The invention can be practiced and distributed in computing environments where tasks or modules are performed by remote processing devices, which are linked by a communications network. Aspects of the invention described herein may be stored or distributed on computer-readable media, including magnetic, optically readable and removable computer disks, as well as distributed electronically over the Internet or other networks (including wireless networks). Those skilled in the relevant art will recognize that portions of the invention reside on a server computer, while corresponding portions may reside on other computers. Data structures and transmissions of data particular to aspects of the invention are also encompassed within the scope of the invention. Additionally, the term “computer” as generally used herein, refers to any data processing device, including portable computers, palm-top computers, personal digital assistants (PDA), Internet appliances, cellular or mobile telephones, wearable computers, set-top boxes, etc.

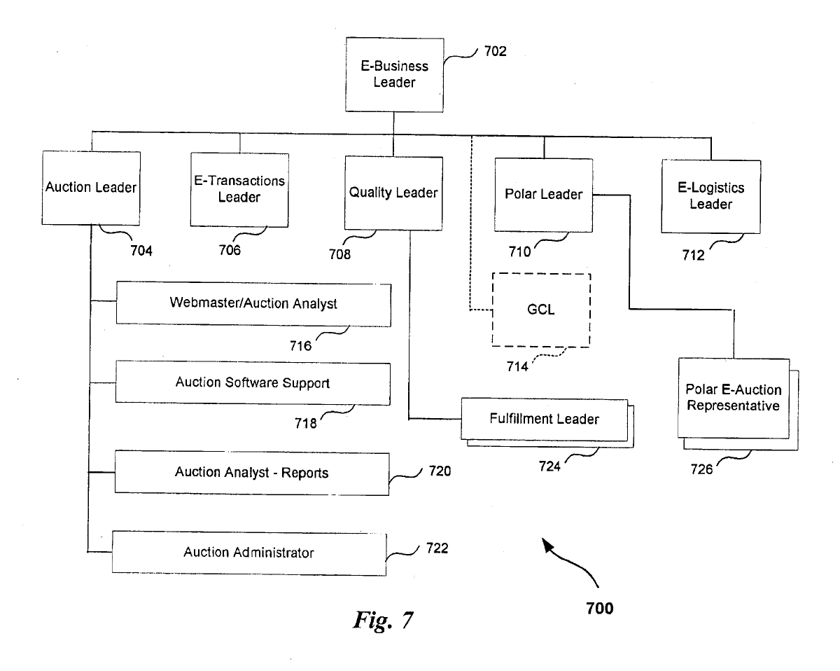

Referring to FIG. 7, an example of an organizational structure for implementing an electronic auction is shown as an organization 700. An electronic or e-business leader 702 governs or manages electronic business transactions, such as electronic procurement. An auction leader 704, electronic transactions leader 706, quality leader 708, poler leader 710, and electronic logistics leader 712 report to the electronic business leader 702. Also, one or more GCLs 714 may report to the electronic business leader 702. A Webmaster and auction analyst 716, auction software support person 718, auction analyst for reports 720 and auction administrator 722, report to the auction leader 704, who oversees or manages the implementation of an electronic auction. The Webmaster 716 manages much of the content and presentation of information under the electronic auction Website, while the software support person 718 acts as a technical lead to facilitate technical aspects of the electronic auction, technical interface issues and technical assistance. The auction analyst for reports 720 manages report generation under the system to track business metrics, business road map implementation and the like. The auction administrator 722 ensures implementation of the electronic auction system internally with respect to the business organization and facilitates use of the electronic auction system with existing and proposed suppliers.

The electronic transaction leader 706 helps ensure that the business organization and suppliers may conduct transactions electronically, such as via EDI and the like. One or more fulfillment leaders 724 report to the quality leader 708 and ensure efficient auction and order processing under the system. The fulfillment leaders ensure quality control, identify problems or issues, and resolve such issues within the organization. One or more pole electronic representatives 726 report to the pole leader 710 and ensure that suppliers within the electronic representative's region are capable of participating in electronic auctions. The electronic logistic leader 712 coordinates and manages electronic logistics, such as electronic RFQs. Of course, in alternative embodiments, some of the positions identified in the organizational structure 700 may be performed by a single person, conversely, a position may be fulfilled by two or more individuals. For example, the pole leader 710 may also be a pole electronic auction representative 726. Alternatively, the electronic auction leader 704 may in fact consist of two or more individuals working together.

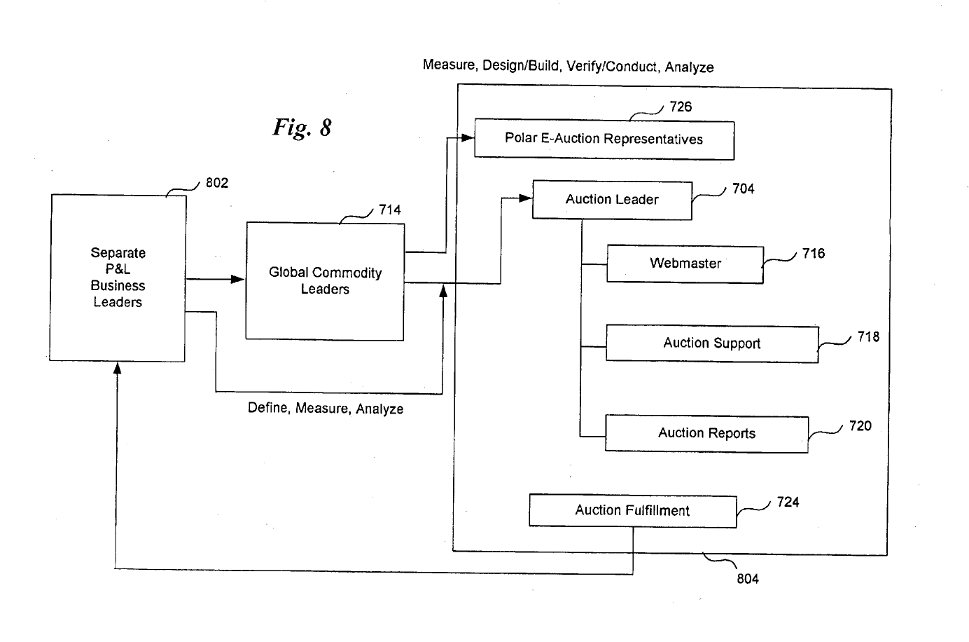

Referring to FIG. 8, the flow of information between separate individuals or groups within the business organization is shown. For example, when a business leader 802 of one of the separate business units identifies the need to procure an item, this need is communicated both to the global commodity leaders 714 and to various members of an electronic auction team 804. The business leader 802 may be a separate individual within the business unit who is assigned to electronic sourcing. The electronic auction team includes the pole electronic auction representative 726, the electronic auction leader 704 (together with Webmaster 706, auction support 718 and auction report personnel 720), and an auction fulfillment person 724. The electronic auction team 804, in turn, provides feedback to the business leaders 802, in the form of business metrics as well as improved item procurement. The business leaders, in turn, provide feedback to the electronic auction team to further refine the electronic requisitioning process.

Many alternatives and alternative embodiments are possible. For example, lines of communication between individuals and groups within the organization to implement aspects of the above procurement systems may be performed using not only the electronic mail system of FIG. 6, but also other communication methods, such as via telephones, via facsimile, etc. As explained above with respect to the method 300, electronic forms may be provided to automate or expedite aspects of a procurement system, such as electronic qualification forms, electronic RFQs, electronic supplier approval and selection, electronic purchase order, MRP, or purchasing forms, etc. These electronic forms may be stored centrally, such as on one or more server computers which may be accessed by the various computers shown in FIG. 6. As a result, many processes necessary to implement procurement may be performed concurrently, such as approving and selecting suppliers, defining a qualification plan, scheduling an auction, preparing an RFQ and/or preparing purchase orders or other necessary legal documents. Indeed, simply defining a qualification plan before executing an auction may lead to great efficiencies in the procurement process.

Transitioning from existing suppliers to new suppliers provides for a great economic and business benefit to the organization. The system may produce electronic purchase orders to purchase stock on hand from an existing supplier before transitioning to a new supplier. The system may automatically prepare and forward such a purchase order, or first pause to receive confirmation from a human operator before sending it. Likewise, the system permits the auction owner to notify the existing supplier of the new supplier, including information regarding the new supplier's winning bid, as well as any other information the auction owner or existing supplier may find valuable. Such information may be conveyed to the existing supplier electronically, such as by electronic mail or by creating and posting a Web page (or other pages herein) that may be accessed by the existing supplier. Access to such Web page may be restricted to only the existing supplier (such as using password protection) or may be accessible by all suppliers who participated in the particular auction.

To facilitate leveraging across business units, the GCL may receive automatic electronic transmissions identifying various procurement requirements by buyers in the business units. Thus, the server computer may automatically send an electronic mail message to each GCL computer identifying procurement requests related to items or commodities for which the GCL is responsible. Alternatively, the server computer may provide flags to an automatic calendaring or docketing system running on GCL computers, which in turn provides automatic notification to the GCL regarding new procurement requests. Based on such notification, the GCL may then access the above-described central forms or Web pages that list new procurement requests or auctions and attempt to consolidate requests. The GCL may have access to records in the MRP system to identify items currently being automatically purchased from existing suppliers to determine whether such items should be subjected to an auction in which the existing suppliers may participate. The GCL may communicate via electronic mail from the posted Web pages, telephone, facsimile machine or other means with individuals within the organization to identify leveraging opportunities. GCLs may coordinate data for cross-business leveraging by employing team collaboration tools, such as QuickPlace, by Lotus Corporation. Alternatively, GCLs may employ shared drives on a intranet or local area network. Furthermore, GCLs may employ standard operating procedures for periodically updating strategic supply information stored within various databases on the servers of the business organization. GCLs, of course, may rely heavily upon buyers of their commodities to contribute to maintaining planning information within shared storage locations.

One skilled in the art will appreciate that the concepts of the above system can be used in various environments other than the Internet. For example, the concepts can also be used in an electronic mail environment in which electronic mail messages may be used to provide information on auctions and to place bids at the auctions. Additionally, various communication channels may be used instead of the Internet, such as a local area network, a wide area network, or a point-to-point dial-up connection. The server system may comprise any combination of hardware or software that can support these concepts. In particular, a Web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.) Moreover, the concepts of the present invention may be applied to auctions that are not supported by computer systems or that are only partially supported by computer systems.

Unless the context clearly requires otherwise, throughout the description and the claims, the words “comprise,” “comprising,” and the like are to be construed in an inclusive sense as opposed to an exclusive or exhaustive sense that is to say, in a sense of “including, but not limited to.” Words using the singular or plural number also include the plural or singular number respectively. Additionally, the words “herein,” “hereunder,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic commerce systems, not only the reverse auction system described above.

The elements and steps of the various embodiments described above can be combined to provide further embodiments. All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all electronic commerce systems that operate under the claims to provide a method for procurement. Accordingly, the invention is not limited by the disclosure, but instead, the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I (we) claim:

1. In a public computer network connecting a buyer organization and two or more supplier computers each having a browser, wherein the supplier computers are coupled to a set of one or more server computers associated with the buyer organization over the public computer network, a method comprising:
at least one server computer in the set of server computers, receiving a request to schedule a reverse auction based on an identified item to procure, wherein the reverse auction is to be conducted a selected number of days in the future;
determining by the buyer organization whether to add additional requests for the identified item, based on the scheduled auction;
creating an electronic qualification plan to qualify the identified item;
approximately concurrently with creating a qualification plan, identifying suppliers to participate in the reverse auction, including suppliers associated with the two supplier computers;
approximately concurrently with identifying suppliers, creating an electronic request for quotations (“RFQ”) with respect to the identified item;
creating a draft electronic purchase order for the identified item before conducting the reverse auction;
at least one server computer in the set of server computers, electronically distributing the electronic RFQ to the at least two supplier computers over the public computer network;
conducting the reverse auction and identifying a winning supplier from the identified suppliers;
transitioning from an existing supplier to the winning supplier; and
at least one server computer in the set of server computers, providing the draft electronic purchase order to the winning supplier to at least procure a number of the identified items for executing the created qualification plan.

2. The method of claim 1 wherein the public computer network is the World Wide Web, wherein the browser is a web browser, and
wherein receiving a request to schedule a reverse auction comprises receiving input, from an electronic purchasing leader, to a web page electronic auction form;
wherein determining whether to add additional requests for the identified item comprises automatically providing to a global commodity leader an electronic copy of the web page auction form, and determining whether suppliers in identified low cost geographic regions may participate;
wherein conducting the reverse auction comprises, at an auction server computer in the set of server computers, electronically providing results of the reverse auction at an expiration of an auction duration;
wherein providing the draft electronic purchase order to the winning supplier comprises creating an electronic purchase order at a purchasing system server computer in the set of server computers; and
wherein the method further comprises, approximately concurrently with creating an electronic RFQ, electronically scheduling the reverse auction with an electronic auction support group.

3. A system for facilitating item procurement from one of two or more suppliers, the system comprising:
at least one server computer coupled to a database, wherein the server computer is configured to:
receive a date when an auction is to be conducted, wherein the auction is for an item to be procured from one of the plurality suppliers, wherein the date is a selected number of days in the future and is stored in the database;
before the date of the auction, provide at least a portion of an electronic qualification plan to qualify the item to be procured, wherein at least the portion of the electronic qualification plan is stored in the database;
assist in the conducting the auction and obtaining winning bid from a winning supplier selected from the two or more suppliers; and
assist in procuring at least a number of the identified items from the winning supplier for executing the created qualification plan before a greater number of the identified items are procured from the winning supplier.

4. The system of claim 3 wherein assisting in conducting the auction comprises assisting in conducting an electronic reverse auction between a buyer computer associated with a buyer organization and supplier computers associated with the two or more suppliers, wherein a public computer network couples the buyer and supplier computers and the server computer; and
wherein the server computer is further configured to provide at least a portion of an electronic request for quotations (“RFQ”) with respect to the item to be procured, and distribute the electronic RFQ to the two or more supplier computers over the public computer network.

5. The system of claim 3 wherein the server computer is further configured to provide at least a portion of an electronic request for quotations (“RFQ”) with respect to the item to be procured, and distribute the electronic RFQ to the two or more suppliers.

6. The system of claim 3 wherein the server computer is 1 further configured to provide notification to at least one member of a qualification team after the winning supplier is identified.

7. The system of claim 3 wherein assisting in conducting the auction comprises assisting in conducting an electronic reverse auction with supplier computers associated with the two or more suppliers, wherein the supplier computers are coupled to the server computer via the Internet.

8. A method of procuring items by a buyer organization from one of two or more suppliers, the method comprising:
identifying an item to procure from one of the two or more suppliers under an auction, wherein the auction is to be conducted a selected number of days in the future;
before conducting the auction creating an electronic qualification plan to qualify the identified item;
conducting the auction and identifying a winning supplier from the two or more suppliers; and
procuring at least a number of the identified item from the winning supplier for executing the created qualification plan before procuring a greater number of the identified items from the winning supplier.

9. The method of claim 8 wherein conducting the auction includes conducting an electronic reverse auction between a buyer computer associated with the buyer organization and supplier computers associated with the two or more suppliers, wherein the buyer and supplier computers are coupled to a public computer network; and
wherein the method further comprises creating an electronic request for quotations (“RFQ”) with respect to the identified item, and distributing the electronic RFQ to the two or more supplier computers over the public computer network.

10. A computer system comprising components configured to perform the method of claim 8.

11. A computer-readable generated data signal transmitted via a transmission channel, the generated data signal encoding contents that cause a computer to perform the method of claim 8.

12. The method of claim 8, further comprising: notifying at least one member of a qualification team after the winning supplier is identified.

13. The method of claim 8, further comprising:
creating a request for quotations (“RFQ”) with respect to the identified item and distributing the RFQ to the at least two suppliers.

14. The method of claim 8, further comprising:
creating a draft purchase order before conducting the auction.

15. A method of procuring items by a buyer organization from one of two or more supplier organizations, the method comprising the steps of:
identifying an item to procure from one of the two or more supplier organizations under an auction;
creating an electronic qualification plan to qualify the identified item;
approximately concurrently with creating a qualification plan, identifying supplier organizations from the two or more supplier organizations to participate in the auction;
approximately concurrently with identifying supplier organizations, creating a request for quotations (“RFQ”) with respect to the identified item;
distributing the RFQ to the identified supplier organizations; and
conducting the auction and identifying a winning supplier organization from the identified supplier organizations.

16. The method of claim 15, further comprising:
creating a draft purchase order before conducting the auction.

17. The method of claim 15 wherein conducting the auction includes conducting an electronic reverse auction between a buyer computer associated with the buyer organization and supplier computers associated with the two or more supplier organizations, wherein the buyer and supplier computers are coupled to a public computer network; and
wherein creating an RFQ comprises creating an electronic request for quotations with respect to the identified item and distributing the electronic RFQ to the two or more supplier computers over the public computer network.

18. A computer-readable medium storing computer-executable instructions, the instructions being capable of causing a computer to perform the method of claim 15.

19. The method of claim 15 wherein identifying supplier organizations includes identifying a set of potential supplier organizations from a larger set of supplier organizations, and approving at least some of the set of identified supplier organizations.

20. The method of claim 15 wherein creating an RFQ includes electronically distributing the RFQ for approval before distributing the RFQ.

21. A data signal encoding computer-executable instructions, the instructions defining a method of facilitating item procurement from one of two or more suppliers, the method comprising:
providing at least a portion of an electronic qualification plan to qualify an item to be procured under an auction;
receiving a set of supplier names identifying suppliers to participate in the auction, wherein the set of supplier names is selected from the two or more suppliers; and
providing at least a portion of a request for quotations (“RFQ”) with respect to the identified item, and wherein providing at least a portion of the RFQ is performed approximately concurrently with providing at least a portion of an electronic qualification plan or receiving a set of supplier names.

22. The data signal encoding computer-executable instructions 1 of claim 21, further comprising:
creating a purchase order before conducting the auction.

23. The data signal encoding computer-executable instructions of claim 21, further comprising:
distributing the RFQ to the set of suppliers; and
conducting the auction and identifying a winning supplier from the set of suppliers.

24. A computer-readable medium storing the data signal of claim 21.

25. The data signal encoding computer-executable instructions of claim 21 wherein providing at least a portion of an electronic qualification plan includes receiving an initial number of the identified item to procure for testing.

26. The data signal encoding computer-executable instructions of claim 21, further comprising:
electronically distributing the RFQ for approval before conducting the auction; and
electronically distributing the set of suppliers for approval before conducting the auction.

27. A method of procuring items from one of two or more supplier organizations, the method comprising:
creating a request for quotations (“RFQ”) with respect to an item to procure from one of the two or more supplier organizations, wherein the item has been procured from an existing supplier organization;
identifying a set of supplier organizations selected from the two or more supplier organizations, wherein the set of supplier organizations are to participate in the auction;
distributing the RFQ to the set of identified supplier organizations;
conducting the auction and identifying a winning supplier organization from the set of identified supplier organizations; and
if the winning supplier organization is not the existing supplier organization, then transitioning from the existing supplier organization to the winning supplier organization, wherein the transitioning includes: procuring any existing numbers of the identified item the existing supplier organization has on hand; automatically generating an electronic message for at least the existing supplier regarding at least one reason why the winning supplier won the auction; or, procuring a number of the identified item from the existing supplier organization to permit uninterrupted transitioning to the winning supplier organization under an automated procurement system (“MRP system”).

28. A computer-readable, medium storing instructions causing a computer to assist in procuring items by a buyer organization from one of two or more supplier organizations, comprising:
receiving a request to schedule an auction based on an identified item to purchase, wherein the auction is to be conducted a selected number of days in the future;
determining by the buyer organization whether to add additional requests for the identified item, based on the scheduled auction and based on additional need for the identified item within the business organization;
creating a request for quotations (“RFQ”) with respect to an item to procure from one of the two or more supplier organizations;
identifying a set of supplier organizations from the two or more supplier organizations to participate in the auction;
distributing the RFQ to the identified set of supplier organizations; and
conducting the auction and identifying a winning supplier organization from the identified set of supplier organizations.

29. The computer-readable medium of claim 28 wherein the computer-readable medium is a logical node in a computer network receiving the instructions.

30. The computer-readable medium of claim 28 wherein the computer-readable medium is a computer-readable disk.

31. The computer-readable medium of claim 28, further comprising receiving an at least partially prepared purchase order before conducting the auction.

32. The computer-readable medium of claim 28 wherein creating the RFQ and identifying a set of supplier organizations are performed substantially concurrently.

33. The computer-readable medium of claim 28, further comprising, before conducting the auction, creating a qualification plan to qualify the identified item.

34. A system to assist in procuring items for a business 1 organization from one of two or more suppliers, comprising:
means for receiving a request to schedule an auction based on an identified item to purchase and an identified quantity, wherein the auction is to be conducted a selected number of days in the future; and
means for determining whether to increase the identified quantity for the item based on the scheduled auction and based on additional need for the identified item within the business organization.

35. The system of claim 34, further comprising:
means for creating a request for quotations (“RFQ”) with respect to the item to procure from one of the two or more suppliers;
means for identifying a select number of suppliers from the two or more suppliers to participate in the auction;
means for distributing the RFQ to the identified suppliers; and
means for conducting the auction and identifying a winning supplier from the identified suppliers.

36. The system of claim 34, further comprising:
means for creating a qualification plan to qualify the identified item before conducting the auction.

37. The system of claim 34, further comprising:
means for creating a request for quotations (“RFQ”) with respect to the item to procure from one of the two or more suppliers; and
means for identifying a select number of suppliers from the two or more suppliers to participate in the auction, wherein the means for creating the RFQ and means for identifying supplier operate approximately concurrently.
